(19) United States
(12) Patent Application Publication
(10) Pub. No.: US 2011/0157667 A1
(43) Pub. Date: Jun. 30, 2011

(54) Holographic Image Display Systems

(76) Inventors: Lilian Lacoste, Cambridge (GB); Edward Buckley, Cambridge (GB); Adrian James Cable, Cambridge (GB); Diego Gil-Leyva, Cambridge (GB); Dominik Stindt, Cambridge (GB)

(21) Appl. No.: 13/000,638

(22) PCT Filed: Jun. 18, 2009
(86) PCT No.: PCT/GB09/50697

§ 371 Date: Mar. 17, 2011

(30) Foreign Application Priority Data
Jun. 26, 2008 (GB) 0811729.3
Apr. 6, 2009 (GB) 0905813.2

(51) Int. Cl. G03H 1/08; G03H 1/22

(52) U.S. Cl. 359/9; 359/13

(57) ABSTRACT

The invention relates to holographic head-up displays, to holographic optical sights, and also to 3D holographic image displays. We describe a holographic head-up display and a holographic optical sight, for displaying, in an eye box of the display/sight, a virtual image comprising one or more substantially two-dimensional images, the head-up display comprising: a laser light source; a spatial light modulator (SLM) to display a hologram of the two-dimensional images; illumination optics in an optical path between said laser light source and said SLM to illuminate said SLM; and imaging optics to image a plane of said SLM comprising said hologram into an SLM image plane in said eye box such that the lens of the eye of an observer of said head-up display performs a space-frequency transform of said hologram on said SLM to generate an image within said observer's eye corresponding to the two-dimensional images.

### CROSS REFERENCE TO RELATED APPLICATION

This application claims priority to PCT Application No. PCT/GB2009/050697 entitled “Holographic Image Display Systems” and filed Jun. 18, 2009, which itself claims priority to Great Britain Patent Application No. GB0905813.2 entitled filed Apr. 6, 2009, and Great Britain Patent Application No. GB0811729.3 filed Jun. 26, 2008. The entirety of each of the aforementioned applications is incorporated herein by reference for all purposes.

### BACKGROUND OF THE INVENTION

This invention relates to holographic head-up displays (HUDs), and to three-dimensional holographic image displays, and also to holographic optical sights, and to related methods and processor control code.

We have previously described techniques for displaying an image holographically—see, for example, WO 2005/059660 (Noise Suppression Using One Step Phase Retrieval), WO 2006/134398 (Hardware for OSPR), WO 2007/031797 (Adaptive Noise Cancellation Techniques), WO 2007/110668 (Lens Encoding), WO 2007/141567 (Color Image Display), and PCT/GB2008/050224 (Head Up Displays—unpublished). These are all hereby incorporated by referenced in their entirety. Reference may also be made to our published applications GB2445958A and GB2444990A.

FIG. 1 shows a traditional approach to the design of a head-up display (HUD), in which lens power is provided by the concave and fold mirrors of the HUD optics in order to form a virtual image, typically displayed at an apparent depth of around 2.5 meters (the distance to which the human eye naturally accommodates).

One problem with conventional head-up displays is the size and complexity of the optics involved. We will describe techniques using a holographic projector which addressed this, and other problems. The techniques we describe also have general application in thee-dimensional holographic image displays. Background prior art relating to computer generated holograms can be found in GB 2,350,961A. Further background prior art is in: U.S. Pat. No. 6,819,495; U.S. Pat. No. 7,319,557; U.S. Pat. No. 7,147,703; EPO 938 691; and US2008/0192045.

Prior art relating to 3D holographic displays can be found in: WO99/27421 (U.S. Pat. No. 7,277,209); WO00/34834 (U.S. Pat. No. 6,621,605); GB2414887; US2001/0013960; EP1657583A; JP09244520A (WPI abstract acc. No. 1997-517424); WO2006/066906; and WO00/07061.

Hence, for at least the aforementioned reasons, there exists a need in the art for advanced systems and methods for display.

### BRIEF DESCRIPTION OF THE DRAWINGS

The invention will further be described, by way of example, with reference to the accompanying drawings, in which:

FIG. 1 shows a conventional example of a head-up display;

FIG. 2 shows a generalized optical system of a virtual image display using a holographic projector;

FIGS. 3a to 3d show, respectively, a block diagram of a hologram data calculation system, operations performed within the hardware block of the hologram data calculation system, energy spectra of a sample image before and after multiplication by a random phase matrix, and an example of a hologram data calculation system with parallel quantizers for the simultaneous generation of two sub-frames from real and imaginary components of complex holographic sub-frame data;

FIGS. 4a and 4b show, respectively, an outline block diagram of an adaptive OSPR-type system, and details of an example implementation of the system;

FIGS. 5a to 5c show, respectively, a color holographic image projection system, and image, hologram (SLM) and display screen planes illustrating operation of the system;

FIG. 6 shows a Fresnel diffraction geometry in which a hologram is illuminated by coherent light, and an image is formed at a distance by Fresnel (or near-field) diffraction;

FIG. 7 shows a virtual image head-up display according to an embodiment of the invention in which hologram patterns displayed on an SLM are Fourier transformed by the eye;

FIGS. 8a and 8b show, respectively, an example of a direct-view 3D holographic display according to an embodiment of the invention, and an example of a 3D holographic projection display according to an embodiment of the invention;

FIGS. 9a to 9c show an example of a Fresnel slice hologram merging procedure suitable for use in embodiments of the invention;

FIG. 10 shows a wireframe cuboid reconstruction resulting from a direct-view 3D holographic display according to an embodiment of the invention, viewed from three camera positions;

FIGS. 11a and 11b show color reconstructions resulting from a direct-view 3D holographic display according to an embodiment of the invention, viewed from two camera positions;

FIG. 12 shows an illustration of the principle of retinal addressing as a particular implementation of the principle showed in FIG. 2;

FIG. 13 shows a block diagram of single channel sights;

FIG. 14 shows a block diagram of single channel holographic sight;

FIG. 15a shows a block diagram of dual channel sight, and FIG. 15b shows a visible limitation of an existing system (auto-focus is normally not available for dual channel);

FIG. 16 shows a block diagram for holographic projection based dual channel sight; and

FIG. 17 shows a block diagram for expanded exit pupil holographic projection based dual channel sight.

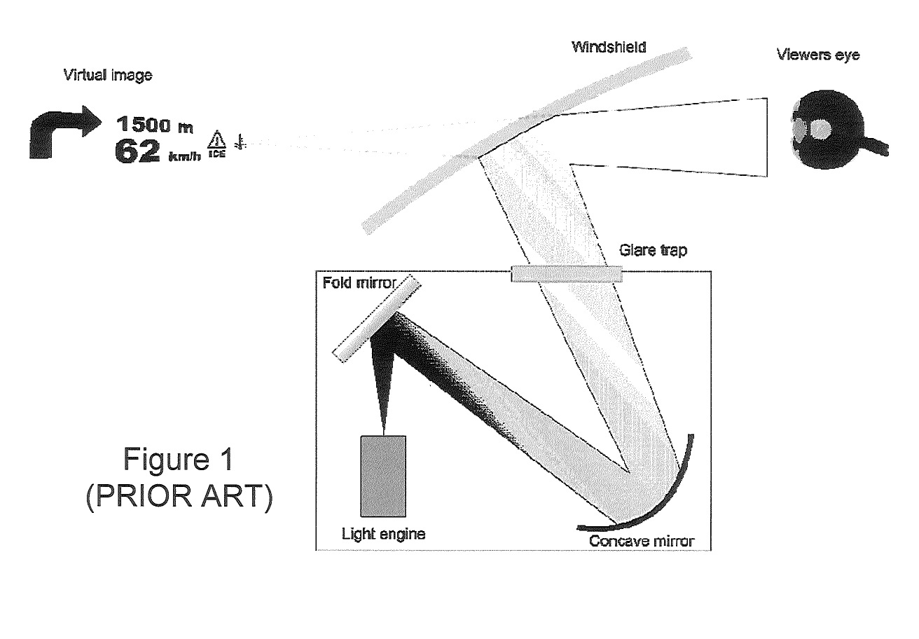

### BRIEF SUMMARY OF THE INVENTION

This invention relates to holographic head-up displays (HUDs), and to three-dimensional holographic image displays, and also to holographic optical sights, and to related methods and processor control code.

According to a first aspect of the present invention there is therefore provided a holographic head-up display (HUD) for displaying, in an eye box of said head-up display, a virtual image comprising one or more substantially two-dimensional images, the head-up display comprising: a laser light source; a spatial light modulator (SLM) to display a hologram of said one or more substantially two-dimensional images; illumination optics in an optical path between said laser light source and said SLM to illuminate said SLM; and imaging optics to image a plane of said SLM comprising said hologram into an SLM image plane in said eye box such that the lens of the eye of an observer of said head-up display performs a space-frequency transform of said hologram on said SLM to generate an image within said observer's eye corresponding to said one or more substantially two-dimensional images.

In embodiments, therefore, the image displayed by the HUD is formed (only) in the observer's eye. Depending on the application, the laser light from the HUD may travel directly from the SLM to the eye, or via folded optics. The SLM may be either transmissive or reflective. The space-frequency transform may comprise, for example, a Fourier transform or a Fresnel transform—although, as described later, a Fresnel transform may be preferred.

In embodiments the eye box of the HUD, that is the space within which the image may be viewed, is enlarged by employing fan-out optics to replicate the image so that it fills a desired light box region. This may be achieved by employing a micro lens array or a one-to-many diffractive beam splitter to provide a plurality of output beams side-by-side one another.

The hologram data may be generated from received image data using a processor implemented in hardware, software, or a combination of the two. In some preferred embodiments the displayed hologram encodes focal power (preferably lens power but potentially a mirror) to bring the displayed image from infinity to a distance of less than 10 meters, preferably less than 5 meters or 3 meters from the observer's eye. Since this focal power is encoded into the hologram together with the displayed image, in embodiments this distance may be adjustable, for example by adjusting the strength of the encoded lens.

In some preferred embodiments the displayed hologram encodes a plurality of substantially two-dimensional images at different focal plane depths such that these appear at different distances from the observer's eye. The skilled person will understand that a single hologram may encode a plurality of different two-dimensional images; in embodiments each of these is encoded with a different lens power, the hologram encoding a combination (sum) of each of these. Thus in embodiments the head-up display is able to display multiple, substantially two-dimensional images at different effective distances from the observer's eye, all encoded in the same hologram.

This approach may be extended so that, for example, one of the image planes can be in a first color and another in a second color. In such a case two different holograms may be employed to encode the two differently colored images (at different depths) and these may be displayed successively on the SLM, controlling a color of the light source in synchrony. Alternatively a more sophisticated, multicolor, three-dimensional approach may be employed, as described further below. It will be appreciated that the ability to display images in different colors and/or at different visual depths is useful for a head-up display since more important imagery (symbology) can be placed, say, in the foreground and less important imagery (symbology) in the background and/or emphasized/de-emphasized using color. For example mapping data may be displayed in the background and, say, warning or alert information displayed in the foreground.

In some preferred implementations an OSPR-type approach is employed to calculate the hologram; such an approach is particularly important when multiple two-dimensional images at different distances are displayed.

According to a related aspect of the invention there is provided a method of providing a holographic head-up display for displaying an image, the method comprising: illuminating a spatial light modulator (SLM) using a coherent light source; displaying a hologram on said illuminated SLM; and imaging a plane of said SLM comprising said hologram into an SLM image plane such that the lens of the eye of an observer of said head-up display performs a space-frequency transform of said hologram on said SLM to generate an image within said observer's eye corresponding to said displayed image.

Applications for head-up displays as described above include, but are not limited to, automotive and aeronautical applications.

Thus the invention also provides corresponding aspects to those described above wherein the head up display is an optical sight. Applications for such holographic optical sights are described later.

According to a further aspect of the invention there is provided a three-dimensional holographic virtual image display system, the system comprising: a coherent light source; a spatial light modulator (SLM), illuminated by said coherent light source, to display a hologram; and a processor having an input to receive image data for display and an output for driving said SLM, and wherein said processor is configured to process said image data and to output hologram data for display on said SLM in accordance with said image data; wherein said image data comprises three-dimensional image data defining a plurality of substantially two-dimensional images at different image planes, and wherein said processor is configured to generate hologram data defining a said hologram encoding said plurality of substantially two-dimensional images, each in combination with a different focal power such that, on replay of said hologram, different said substantially two-dimensional images are displayed at different respective distances from an observer's eye to give an observer the impression of a three-dimensional image.

Embodiments of the display system are thus able to provide a three-dimensional display at substantially reduced computational cost, provided the compromise of a limited number of two-dimensional image slices in the depth (z) direction is accepted. In embodiments by representing the three-dimensional image as a set of two-dimensional image slices, preferably substantially planar and preferably substantially parallel to one another, at successive, preferably regularly increasing steps of visual depth a realistic 3D effect may be created without an impractical computational cost and bandwidth to the SLM. In effect resolution in the z-direction is being traded. Thus in embodiments the z-direction resolution is less than a minimum lateral resolution in the x-or y-directions (perpendicular directions within one of the two-dimensional image slices). In embodiments the resolution in the z-direction, that is the number of slices, may be less than 10, 5 or 3, although in other embodiments, for a more detailed three-dimensional image, the number of slices in the z (depth) direction may be greater than 10, 50, 100 or 200.

One of the advantages of generating a three-dimensional display using holography is that the 3D image is potentially able to replicate the light from a “real” 3D scene including one or more of potentially all of (the 3D cues human beings employ for 3D perception: parallax, focus (to match apparent distance), accommodation (since an eye is not a pinhole each eye in fact sees a small range of slightly different views), and stereopsis.

In some preferred embodiments the processor is configured (either in hardware, or by means of control code, or using a combination of both these) to extract two-dimensional image slices from three-dimensional image data, and for each of these to calculate a hologram including lens power to displace the replayed image to an appropriate depth in the replayed 3D image, to match the location of the slice in the input 3D image. These holograms are then combined into a common hologram encoding some or all of the 2D image slices, for display on the SLM. In preferred embodiments a Fresnel transform is used to encode the appropriate lens power to displace a replayed slice to a position in the replayed 3D image which matches that of the slice in the original, input image.

In some preferred implementations the light source is time-multiplexed to provide at least two different colors, for example red, green and blue wavelengths. A displayed hologram may then be synchronized to display corresponding, for example red, green and blue color components of the desired 3D image. One problem which would arise in a color holographic 3D image display is that voxels for different wavelengths would be of different sizes. However a color 3D holographic image display of the type we describe above can address this problem by arranging for the displayed hologram data to be scaled such that pixels of different colors (wavelengths) have substantially the same lateral dimensions within each 2D image plane. This can be achieved with relatively little processing burden. One approach is to pad the different red, green and blue input images, for example with zeros, to increase the number of pixels in proportion to the wavelength (so that the red image has more pixels than the blue image), prior to performing a holographic transform. Another approach is to upsize shorter wavelength (blue and green) color planes prior to hologram generation by performing a holographic transform. For example the blue, and to a lesser extent green, color planes may be upsized in proportion to wavelength and then all the color planes may be padded, for example with zeros, so that the input images are of the same numbers of pixels in each (x- and y-) direction, for example matching the x- and y- resolution of the SLM, then performing the holographic transform. Further details of these approaches can be found in WO 2007/141567 (hereby incorporated by reference).

It will be appreciated that embodiments of the techniques described above provide a practical approach to achieving a full color, 3D holographic image display using currently available technology. In embodiments moving full color 3D holographic images may even be displayed, for example at a frame rate of greater than or equal to 10 fps, 15 fps, 20 fps, 25 fps or 30 fps.

To achieve such a display it is strongly preferable to employ an OSPR-type approach to calculating the holograms for display, because of the substantial reduction in computational cost of such an approach. In embodiments, therefore, for each displayed hologram a plurality of temporal holographic subframes is calculated each corresponding to a noisy version of the image intended for replay and the hologram is displayed by displaying these temporal subframes in rapid succession so that, in the observer's eye, a reduced noise version of the image intended for display is formed. Thus in embodiments of the system the displayed hologram comprises a plurality of holographic subframes each of which replays the same part of the displayed image, but with different noise, such that the overall perception of noise is reduced. In some particularly preferred embodiments an adaptive technique is employed in which the noise in one subframe at least partially compensates for the noise introduced by one or more previous subframes, as described in our earlier PCT patent application WO 2007/031797 (hereby incorporated by reference).

In embodiments of the display system it is not essential to employ output optics between the SLM and the observer. However in embodiments imaging optics to image the SLM plane (which is the hologram plane) are employed optionally with fan-out optics, as described above. Preferably a beam expander is employed prior to the SLM, in part to facilitate direct viewing of the 3D image display.

In a related aspect the invention provides a carrier carrying processor control code for implementing a method of displaying a three-dimensional virtual holographic image, the code comprising code to: input three-dimensional image data defining a plurality of substantially two-dimensional images at different image planes; generate hologram data defining a hologram encoding said plurality of substantially two-dimensional images, each in combination with a different focal power corresponding to a respective said image plane; and output said hologram data for displaying said hologram on a spatial light modulator illuminated by coherent light such that different said substantially two-dimensional images are displayed at different respective distances from an observer's eye to give an observer the impression of a three-dimensional image.

The carrier may be, for example, a disk, CD- or DVD-ROM, or programmed memory such as read-only memory (Firmware). The code (and/or data) may comprise source, object or executable code in a conventional programming language (interpreted or compiled) such as C, or assembly code, for example for general purpose computer system or a digital signal processor (DSP), or the code may comprise code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a further related aspect the invention provides a method of displaying a three-dimensional virtual holographic image, the method comprising: inputting three-dimensional image data defining a plurality of substantially two-dimensional images at different image planes; generating hologram data defining a hologram encoding said plurality of substantially two-dimensional images, each in combination with a different focal power corresponding to a respective said image plane; illuminating a spatial light modulator (SLM) using a coherent light source; and displaying said hologram on said SLM such that different said substantially two-dimensional images are displayed at different respective distances from an observer's eye to give an observer the impression of a three-dimensional image.

In a still further aspect the invention provides a three-dimensional holographic image projection system, the system comprising: a spatial light modulator (SLM) to display a hologram: a coherent light source to illuminate said hologram; and a processor configured to input 3D image data and to encode said 3D image data into a hologram as a plurality of 2D slices of said 3D image each with lens power corresponding to a respective visual depth of the 2D slice within the 3D image, and wherein said processor is configured to drive said SLM to display said hologram such that, in use, the system is able to form a projected said three-dimensional holographic image optically in front of said output lens.

The projected image will be optically in front of the output lens but may, for example, be reflected or folded so that it is physically to one side of the output lens.

This summary provides only a general outline of some embodiments of the invention. Many other objects, features, advantages and other embodiments of the invention will become more fully apparent from the following detailed description, the appended claims and the accompanying drawings.

### DETAILED DESCRIPTION

This invention relates to holographic head-up displays (HUDs), and to three-dimensional holographic image displays, and also to holographic optical sights, and to related methods and processor control code.

Preferred embodiments of the invention use an OSPR-type hologram generation procedure, and we therefore describe examples of such procedures below. However embodiments of the invention are not restricted to such a hologram generation procedure and may be employed with other types of hologram generation procedure including, but not limited to: a Gerchberg-Saxton procedure (R. W. Gerchberg and W. O. Saxton, “A practical algorithm for the determination of phase from image and diffraction plane pictures” Optik 35, 237-246 (1972)) or a variant thereof, Direct Binary Search (M. A. Seldowitz, J. P. Allebach and D. W. Sweeney, “Synthesis of digital holograms by direct binary search” Appl. Opt. 26, 2788-2798 (1987)), simulated annealing (see, for example, M. P. Dames, R. J. Dowling, P. McKee, and D. Wood, “Efficient optical elements to generate intensity weighted spot arrays: design and fabrication,” Appl. Opt. 30, 2685-2691 (1991)), or a POCS (Projection Onto Constrained Sets) procedure (see, for example, C. -H. Wu, C. -L. Chen, and M. A. Fiddy, “Iterative procedure for improved computer-generated-hologram reconstruction,” Appl. Opt. 32, 5135-(1993)).

### OSPR

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram, each of which spatially overlaps in the replay field (in embodiments each has the spatial extent of the displayed image).

Each sub-frame when viewed individually would appear relatively noisy because noise is added, for example by phase quantization by the holographic transform of the image data. However when viewed in rapid succession the replay field images average together in the eye of a viewer to give the impression of a low noise image. The noise in successive temporal subframes may either be pseudo-random (substantially independent) or the noise in a subframe may be dependent on the noise in one or more earlier subframes, with the aim of at least partially cancelling this out, or a combination may be employed. Such a system can provide a visually high quality display even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms may form replay fields that exhibit mutually independent additive noise. An example is shown below:

$$1. Let {G}_{xy}^{( n )} = {I}_{xy} exp ( {jϕ}_{xy}^{( n )} ) where {ϕ}_{xy}^{( n )} is uniformly distributed between 0 and 2 π for 1 \leq n \leq N / 2 and 1 \leq x , y \leq m$$

$$2. Let {g}_{uv}^{( n )} = {F}^{- 1} [ {G}_{xy}^{( n )} ] where {F}^{- 1} represents the two \text{-} dimensional inverse Fourier transform operator , for 1 \leq n \leq N / 2$$

$$3. Let {m}_{uv}^{( n )} = \{ {g}_{uv}^{( n )} \} for 1 \leq n \leq N / 2$$

$$4. Let {m}_{uv}^{( n + N / 2 )} = \{ {g}_{uv}^{( n )} \} for 1 \leq n \leq N / 2$$

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} \\ where {Q}^{( n )} = median ( {m}_{uv}^{( n )} ) and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

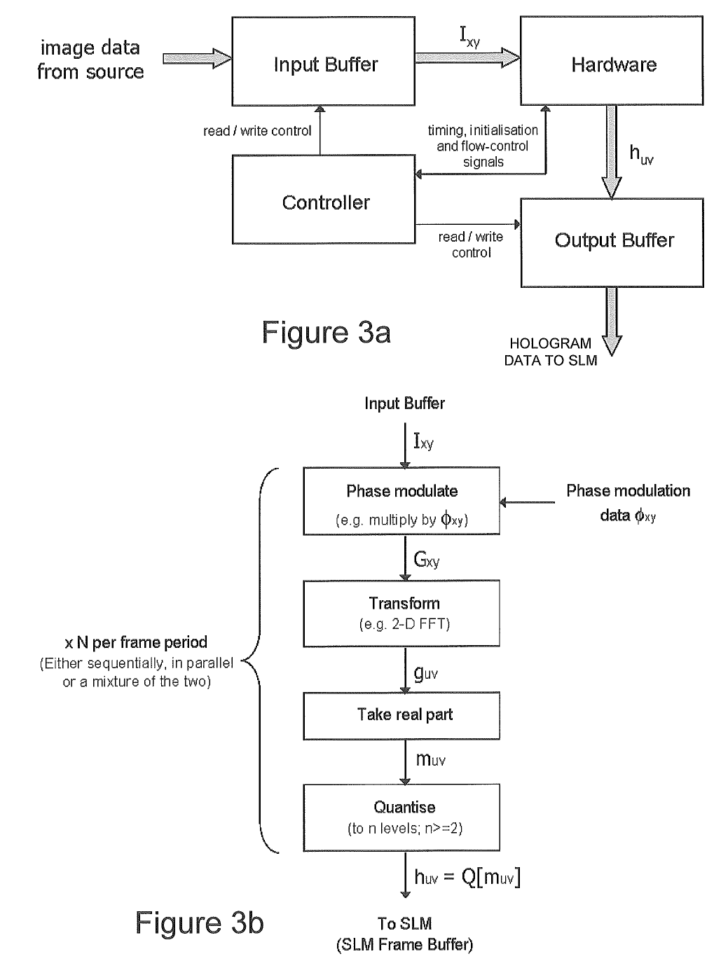

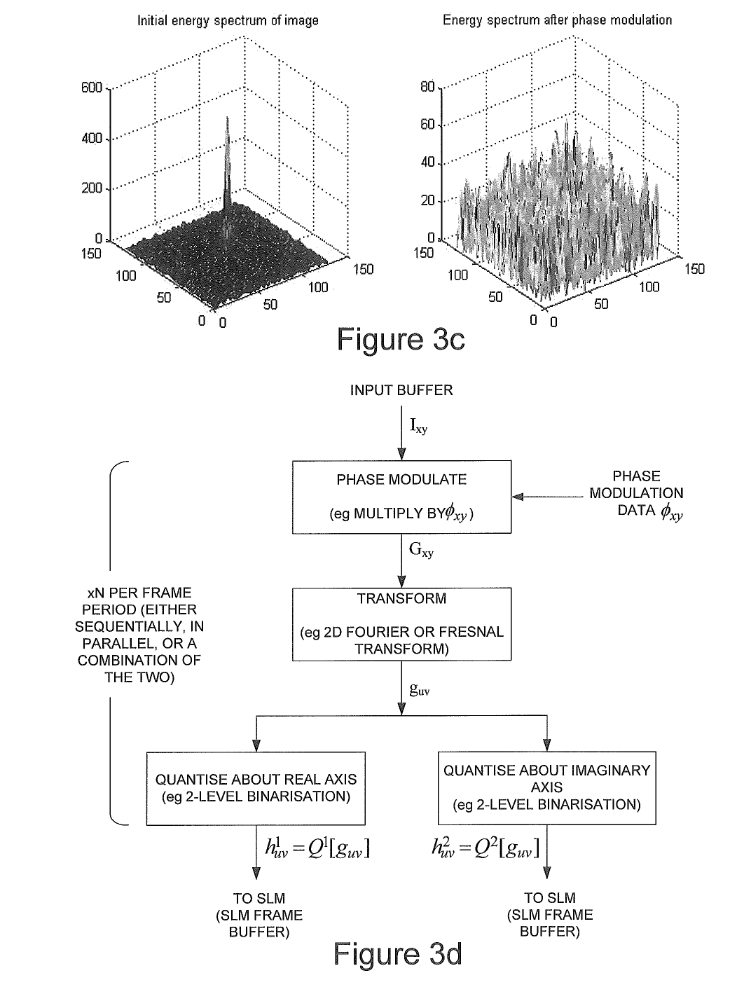

FIG. 3a, from our WO2006/134398, shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 3b shows details of the hardware block of FIG. 3a; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantization stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block is to redistribute the energy of the input frame in the spatial-frequency domain, such that improvements in final image quality are obtained after performing later operations. FIG. 3c shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantization block takes complex hologram data, which is produced as the output of the preceding space-frequency transform block, and maps it to a restricted set of values, which correspond to actual modulation levels that can be achieved on a target SLM (the different quantized phase retardation levels may need not have a regular distribution). The number of quantization levels may be set at two, for example for an SLM producing phase retardations of 0 or π at each pixel.

In embodiments the quantizer is configured to separately quantise real and imaginary components of the holographic sub-frame data to generate a pair of holographic sub-frames, each with two (or more) phase-retardation levels, for the output buffer. FIG. 3d shows an example of such a system. It can be shown that for discretely pixellated fields, the real and imaginary components of the complex holographic sub-frame data are uncorrelated, which is why it is valid to treat the real and imaginary components independently and produce two uncorrelated holographic sub-frames.

An example of a suitable binary phase SLM is the SXGA (1280×1024) reflective binary phase modulating ferroelectric liquid crystal SLM made by CRL Opto (Forth Dimension Displays Limited, of Scotland, UK). A ferroelectric liquid crystal SLM is advantageous because of its fast switching time. Binary phase devices are convenient but some preferred embodiments of the method use so-called multiphase spatial light modulators as distinct from binary phase spatial light modulators (that is SLMs which have more than two different selectable phase delay values for a pixel as opposed to binary devices in which a pixel has only one of two phase delay values). Multiphase SLMs (devices with three or more quantized phases) include continuous phase SLMs, although when driven by digital circuitry these devices are necessarily quantized to a number of discrete phase delay values. Binary quantization results in a conjugate image whereas the use of more than binary phase suppresses the conjugate image (see WO 2005/059660).

### Adaptive OSPR

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N². An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality:

An optional pre-processing step performs gamma correction to match a CRT display by calculating T(x, y)^{1.3}. Then at each stage n (of N stages) an array F (zero at the procedure start) keeps track of a “running total” (desired image, plus noise) of the image energy formed by the previous holograms H₁ to Hₙ₋₁ so that the noise may be evaluated and taken into account in the subsequent stage: F(x, y):=F(x, y)+|F[Hₙ₋₁(x, y)]|². A random phase factor φ is added at each stage to each pixel of the target image, and the target image is adjusted to take the noise from the previous stages into account, calculating a scaling factor α to match the intensity of the noisy “running total” energy F with the target image energy (T′)². The total noise energy from the previous n−1 stages is given by αF−(n−1)(T′)², according to the relation

$$α := \frac{{\sum }_{x , y} {{T}^{′} ( x , y )}^{4}}{{\sum }_{x , y} F ( x , y ) \cdot {{T}^{′} ( x , y )}^{2}}$$

and therefore the target energy at this stage is given by the difference between the desired target energy at this iteration and the previous noise present in order to cancel that noise out, i.e. (T′)²−[αF−(n−1)(T′)²]=n(T′)²+αF. This gives a target amplitude |T″| equal to the square root of this energy value, i.e.

$${T}^{″} ( x , y ) := \{ \begin{matrix}\sqrt{2 {{T}^{′} ( x , y )}^{2} - α F} \cdot exp \{ j φ ( x , y ) \} & if 2 {{T}^{′} ( x , y )}^{2} > α F \\ 0 & otherwise\end{matrix}$$

At each stage n, H represents an intermediate fully-complex hologram formed from the target T″ and is calculated using an inverse Fourier transform operation. It is quantized to binary phase to form the output hologram Hₙ, i.e.

$$H ( x , y ) := {F}^{- 1} [ {T}^{″} ( x , y ) ]$$

$${H}_{n} ( x , y ) = \{ \begin{matrix}1 & if Re [ H ( x , y ) ] > 0 \\ - 1 & otherwise\end{matrix}$$

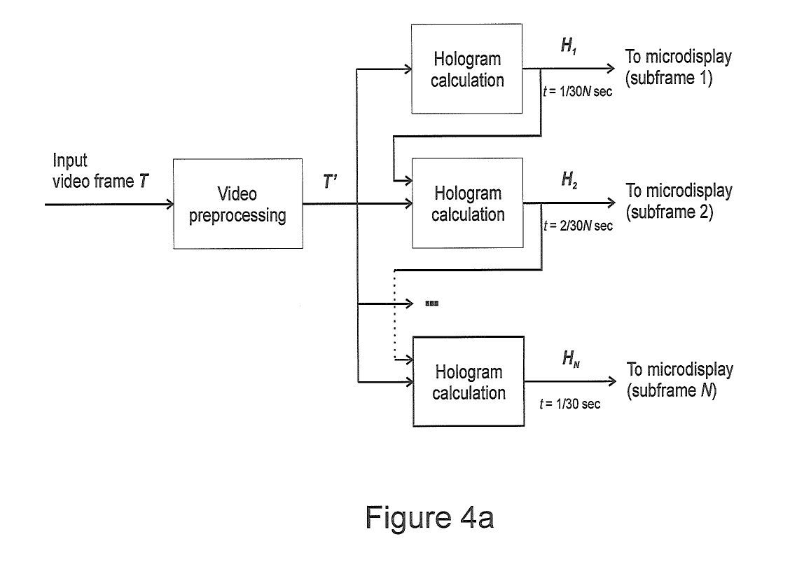

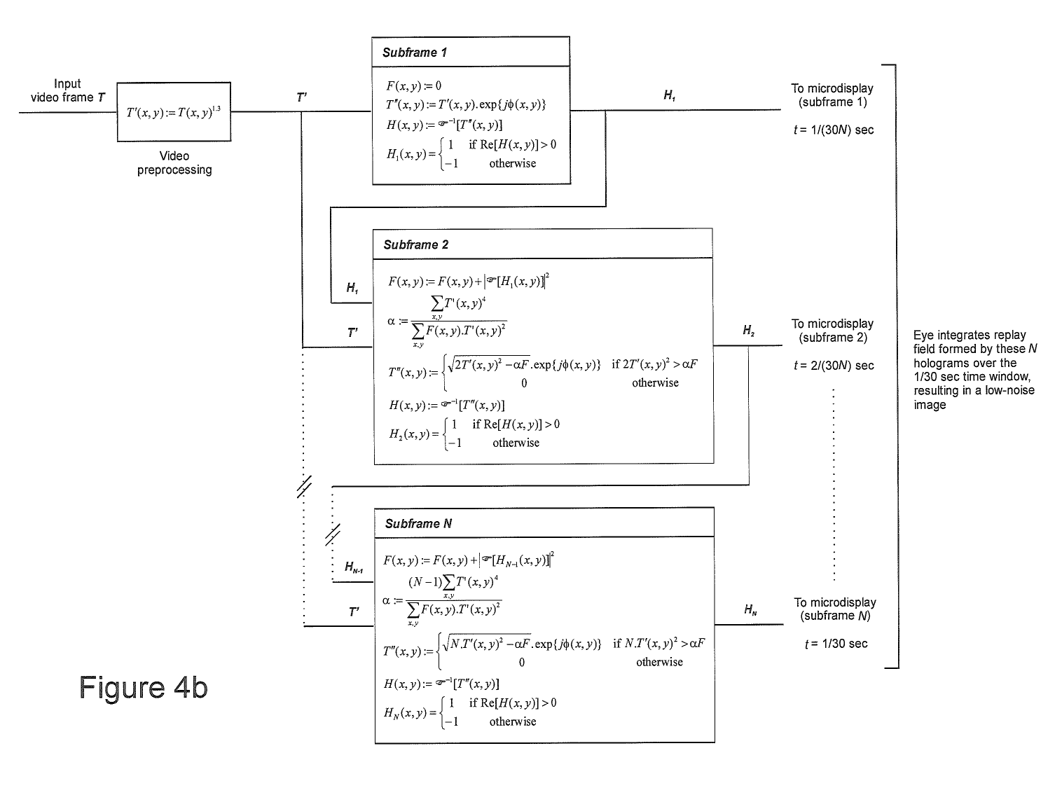

FIG. 4a outlines this method and FIG. 4b shows details of an example implementation, as described above.

Thus, broadly speaking, an ADOSPR-type method of generating data for displaying an image (defined by displayed image data, using a plurality of holographically generated temporal subframes displayed sequentially in time such that they are perceived as a single noise-reduced image), comprises generating from the displayed image data holographic data for each subframe such that replay of these gives the appearance of the image, and, when generating holographic data for a subframe, compensating for noise in the displayed image arising from one or more previous subframes of the sequence of holographically generated subframes. In embodiments the compensating comprises determining a noise compensation frame for a subframe; and determining an adjusted version of the displayed image data using the noise compensation frame, prior to generation of holographic data for a subframe. In embodiments the adjusting comprises transforming the previous subframe data from a frequency domain to a spatial domain, and subtracting the transformed data from data derived from the displayed image data.

More details, including a hardware implementation, can be found in WO2007/141567 hereby incorporated by reference.

### Color Holographic Image Projection

The total field size of an image scales with the wavelength of light employed to illuminate the SLM, red light being diffracted more by the pixels of the SLM than blue light and thus giving rise to a larger total field size. Naively a color holographic projection system could be constructed by superimposed simply three optical channels, red, blue and green but this is difficult because the different color images must be aligned. A better approach is to create a combined beam comprising red, green and blue light and provide this to a common SLM, scaling the sizes of the images to match one another.

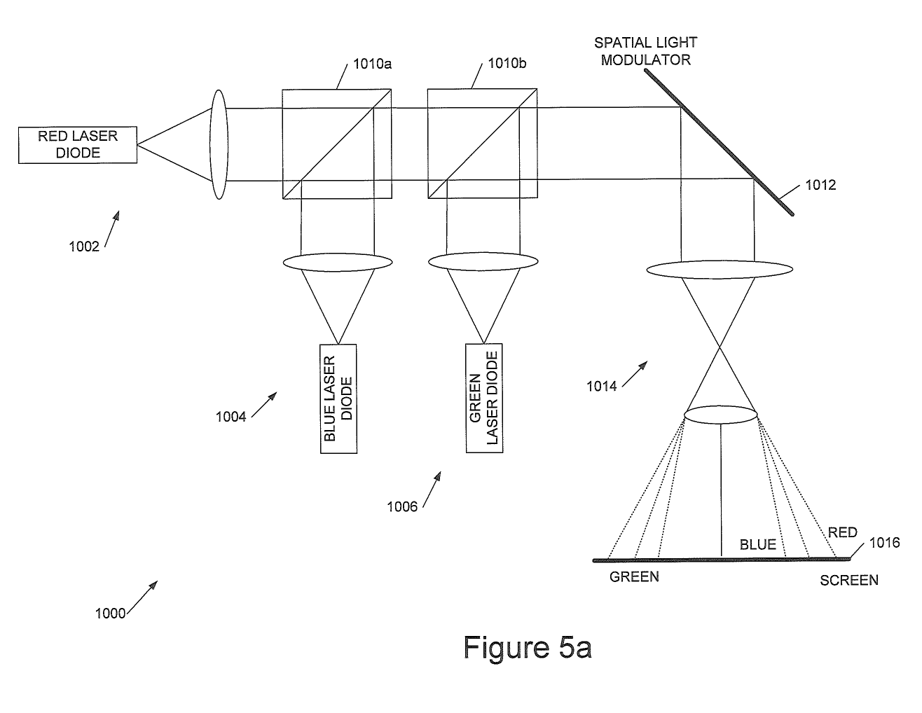

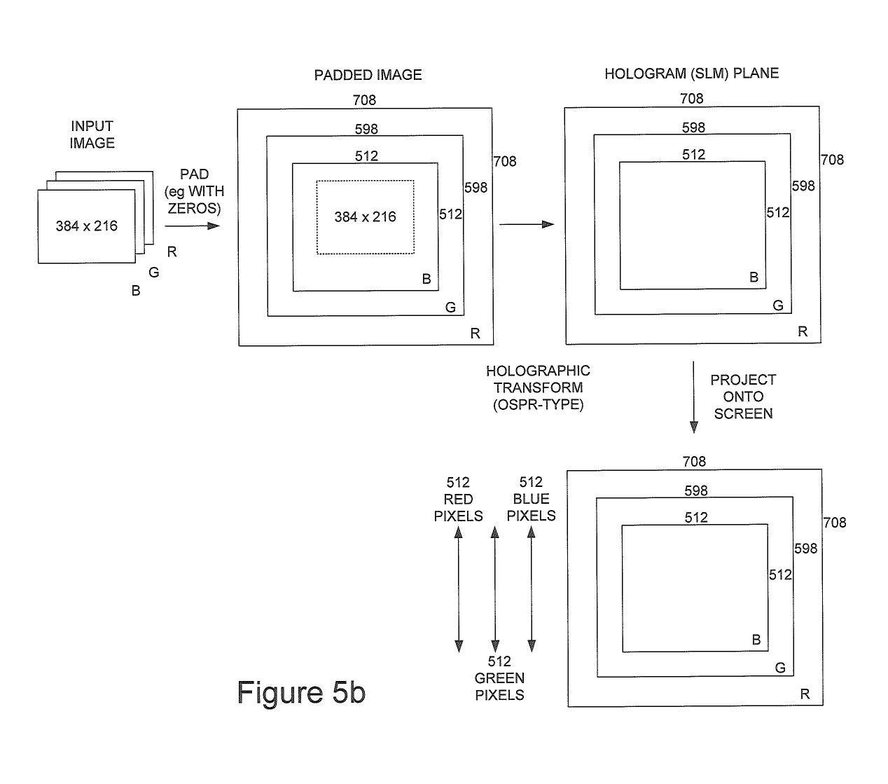

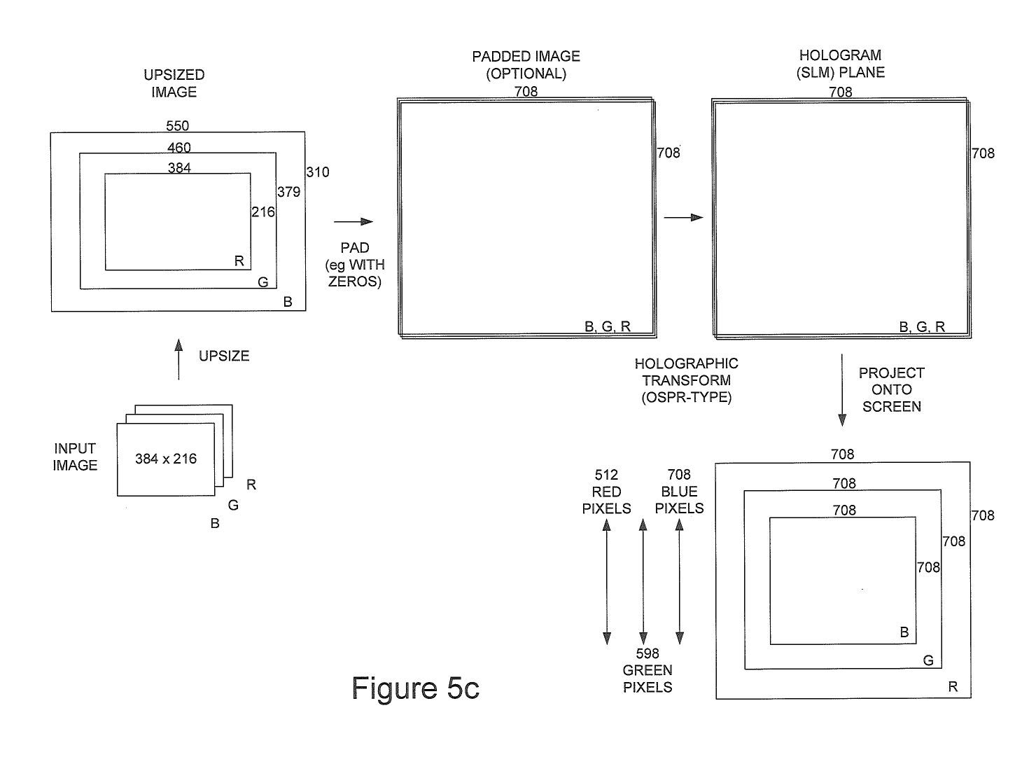

FIG. 5a shows an example color holographic image projection system 1000, here including demagnification optics 1014 which project the holographically generated image onto a screen 1016. The system comprises red 1002, green 1006, and blue 1004 collimated laser diode light sources, for example at wavelengths of 638 nm, 532 nm and 445 nm, driven in a time-multiplexed manner. Each light source comprises a laser diode 1002 and, if necessary, a collimating lens and/or beam expander. Optionally the respective sizes of the beams are scaled to the respective sizes of the holograms, as described later. The red, green and blue light beams are combined in two dichroic beam splitters 1010a, b and the combined beam is provided (in this example) to a reflective spatial light modulator 1012; the figure shows that the extent of the red field would be greater than that of the blue field. The total field size of the displayed image depends upon the pixel size of the SLM but not on the number of pixels in the hologram displayed on the SLM.

FIG. 5b shows padding an initial input image with zeros in order to generate three color planes of different spatial extents for blue, green and red image planes. A holographic transform is then performed on these padded image planes to generate holograms for each sub-plane; the information in the hologram is distributed over the complete set of pixels. The hologram planes are illuminated, optionally by correspondingly sized beams, to project different sized respective fields on to the display screen. FIG. 5c shows upsizing the input image, the blue image plane in proportion to the ratio of red to blue wavelength (638/445), and the green image plane in proportion to the ratio of red to green wavelengths (638/532) (the red image plane is unchanged). Optionally the upsized image may then be padded with zeros to a number of pixels in the SLM (preferably leaving a little space around the edge to reduce edge effects). The red, green and blue fields have different sizes but are each composed of substantially the same number of pixels, but because the blue, and green images were upsized prior to generating the hologram a given number of pixels in the input image occupies the same spatial extent for red, green and blue color planes. Here there is the possibility of selecting an image size for the holographic transform procedure which is convenient, for example a multiple of 8 or 16 pixels in each direction.

### Lens Encoding

We now describe encoding lens power into the hologram by means of Fresnel diffraction. We have previously described systems using far-field (or Fraunhofer) diffraction, in which the replay field F_{xy} and hologram hᵤᵥ are related by the Fourier transform:

F_{xy}=F[hᵤᵥ] (1)

In the near-field (or Fresnel) propagation regime, RPF and hologram are related by the Fresnel transform which, using the same notation, can be written as:

F_{xy}=FR[hᵤᵥ] (2)

The discrete Fresnel transform, from which suitable binary-phase holograms can be generated, is now introduced and briefly discussed.

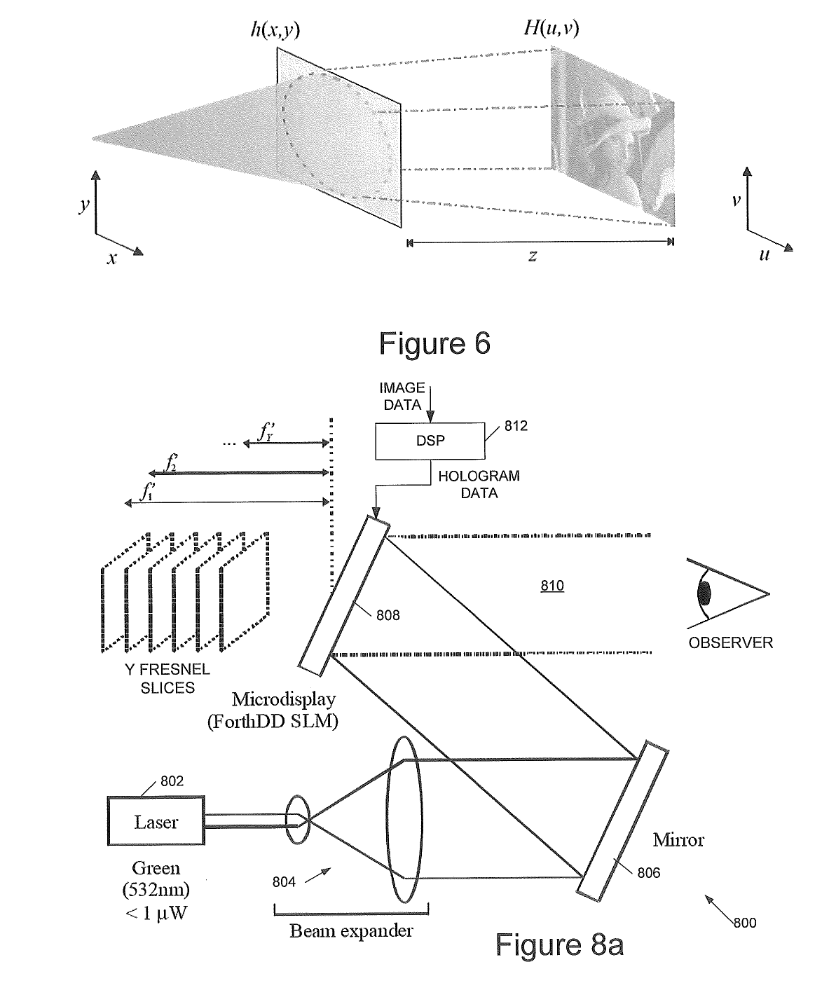

Referring to FIG. 6, the Fresnel transform describes the diffracted near field F(x, y) at a distance z, which is produced when coherent light of wavelength λ interferes with an object h(u, v). This relationship, and the coordinate system, is illustrated in the Figure. In continuous coordinates, the transform is defined as:

$$F ( x ) = \frac{{e}^{\frac{j 2 π z}{λ}}}{j λ z} \int h ( u ) exp \{ - \frac{jπ}{λ z} {‖ x - u ‖}^{2} ) d u \qquad ( 3 )$$

where x=(x, y) and u=(u, v), or

$$F ( x , y ) = \frac{{e}^{\frac{j2π z}{λ}}}{jλ z} {e}_{- ∞}^{\frac{jπ}{λ z} {( {x}^{2} + {y}^{2} )}_{∞}} h ( u , v ) {e}^{\frac{j π}{λ z} ( {u}^{2} + {v}^{2} )} exp \{ - \frac{2 j π}{λ z} ( ux + vy ) \} d u d v . \qquad ( 4 )$$

This formulation is not suitable for a pixellated, finite-sized hologram h_{xy}, and is therefore discretized. This discrete Fresnel transform can be expressed in terms of a Fourier transform

$$\begin{matrix}{H}_{xy} = {F}_{xy}^{( 1 )} \cdot F [ {F}_{uv}^{( 2 )} {h}_{uv} ] \\ where & ( 5 ) \\ {F}_{xy}^{( 1 )} = \frac{{Δ}_{x} {Δ}_{y}}{jλ z} exp \frac{j2π z}{λ} exp \frac{jπ}{λ z} [ {( \frac{x}{N {Δ}_{x}} )}^{2} + {( \frac{y}{M {Δ}_{y}} )}^{2} ] \\ and & ( 6 ) \\ {F}_{uv}^{( 2 )} = exp \frac{jπ}{λ z} ( {u}^{2} {Δ}_{x} + {v}^{2} {Δ}_{y} ) . & ( 7 )\end{matrix}$$

In effect the factors F⁽¹⁾ and F⁽²⁾ in equation (5) turn the Fourier transform in a Fresnel transform of the hologram h. The size of each hologram pixel is Δₓ×Δ_{y}, and the total size of the hologram is (in pixels) N×M. In equation (7), z defines the focal length of the holographic lens. Finally, the sample spacing in the replay field is:

$${Δ}_{u} = \frac{λ z}{N {Δ}_{x}} \\ {Δ}_{v} = \frac{λ z}{N {Δ}_{y}} \qquad ( 8 )$$

so that the dimensions of the replay field are

$$\frac{λ z}{{Δ}_{x}} \times \frac{λ z}{{Δ}_{y}} ,$$

consistent with the size of replay field in the Fraunhofer diffraction regime.

The OSPR algorithm can be generalized to the case of calculating Fresnel holograms by replacing the Fourier transform step by the discrete Fresnel transform of equation 5. Comparison of equations 1 and 5 show that the near-field propagation regime results in different replay field characteristics. One advantage associated with binary Fresnel holograms is that the diffracted near-field does not contain a conjugate image. In the Fraunhofer diffraction regime the replay field is the Fourier transform of the real term hᵤᵥ, giving rise to conjugate symmetry. In the case of Fresnel diffraction, however, equation 5 shows that the replay field is the Fourier transform of the complex term Fᵤᵥ⁽²⁾hᵤᵥ.

It can be seen from equation 4 that the diffracted field resulting from a Fresnel hologram is characterized by a propagation distance z, so that the replay field is formed in one plane only, as opposed to everywhere where z is greater than the Goodman distance [J. W. Goodman, Introduction to Fourier Optics, 2nd ed. New York: McGraw-Hill, 1996, ch. The Fraunhofer approximation, pp. 73-75] in the case of Fraunhofer diffraction. This indicates that a Fresnel hologram incorporates lens power (a circular structure can be seen in a Fresnel hologram). Further, the focal plane in which the image is formed can be altered by recalculating the hologram rather than changing the entire optical design.

There can be an increase in SNR when using Fresnel holograms in a procedure which takes the real (or imaginary) part of the complex hologram, because the Fresnel transform is not conjugate symmetric. However error diffusion, for example, may be employed to mitigate this—see our WO 2008/001137 and WO2008/059292. The use of near-field holography also results in a zero-order which is approximately the same size as the hologram itself, spread over the entire replay field rather than located at zero spatial frequency as for the Fourier case. However this large zero order can be suppressed either with a combination of a polariser and analyzer or, for example, by processing the hologram pattern [C. Liu, Y. Li, X. Cheng, Z. Liu, et al., “Elimination of zero-order diffraction in digital holography,” Optical Engineering, vol. 41, 2002].

We now describe an implementation of a hologram processor, in this example using a modification of the above described OSPR procedure, to calculate a Fresnel hologram using equation (5). Other OSPR-type procedures may be similarly modified.

Referring back to steps 1 to 5 of the above described OSPR procedure, step 2 was previously a two-dimensional inverse Fourier transform. To implement a Fresnel hologram, also encoding a lens, as described above an inverse Fresnel transform is employed in place of the previously described inverse Fourier transform. The inverse Fresnel transform may take the following form (based upon equation (5) above):

$$\frac{{F}^{- 1} [ \frac{{H}_{xy}}{{F}_{xy}^{( 1 )}} ]}{{F}_{uv}^{( 2 )}}$$

Similarly the transform shown in FIG. 3b is a two-dimensional inverse Fresnel transform (rather than a two-dimensional FFT) and, likewise the transform in FIG. 3d is a Fresnel (rather than a Fourier) transform. In the hardware a one-dimensional FFT block is replaced by an FRT (Fresnel transform) block and the scale factors F_{xy} and Fᵤᵥ mentioned above are preferably incorporated within the block.

### Aberration Correction

The procedure of FIG. 3d may be modified to perform aberration correction for an optical sight display. The additional step is to multiply the hologram data by a conjugate of the distorted wavefront, which may be determined from a ray tracing simulation software package such as ZEMAX. In some preferred embodiments the (conjugate) wavefront correction data is stored in non-volatile memory. Any type of non-volatile memory may be employed including, but not limited to, Flash memory and various types of electrically or mask programmed ROM (Read Only Memory). There are a number of ways in which the wavefront correction data may be obtained. For example a wavefront sensor may be employed to determine aberration in a physical model of the optical system by employing a wavefront sensor such as a Shack-Hartman or interferogram-based wavefront sensor. By employing this data in a holographic image projection system broadly of the type previously described a display may also be tailored or configured for a particular user.

In some embodiments the wavefront correction may be represented in terms of Zernike modes. Thus a wavefront W=exp (i Ψ) may be expressed as an expansion in terms of Zernike polynomials as follows:

$$W = exp ( iΨ ) = exp ( i {\sum }_{j} {a}_{j} {Z}_{j} ) \qquad ( 11 )$$

Where Zⱼ is a Zernike polynomial and aⱼ is a coefficient of Zⱼ. Similarly a phase conjugation of the Ψ_{c} of the wavefront Ψ may be represented as:

$${Ψ}_{c} = {\sum }_{j} {c}_{j} {Z}_{j} \qquad ( 12 )$$

For correcting the wavefront preferably Ψ_{c}␣Ψ. Thus for (uncorrected) hologram data gᵤᵥ (although hᵤᵥ is also used above with reference to lens encoding), the corrected hologram data gᵤᵥ^{c} can be expressed as follows:

gᵤᵥ^{c}=exp(i Ψ_{c})gᵤᵥ (13)

For further details, reference may be made to our WO 2008/120015, hereby incorporated by reference.

### Virtual Image Display

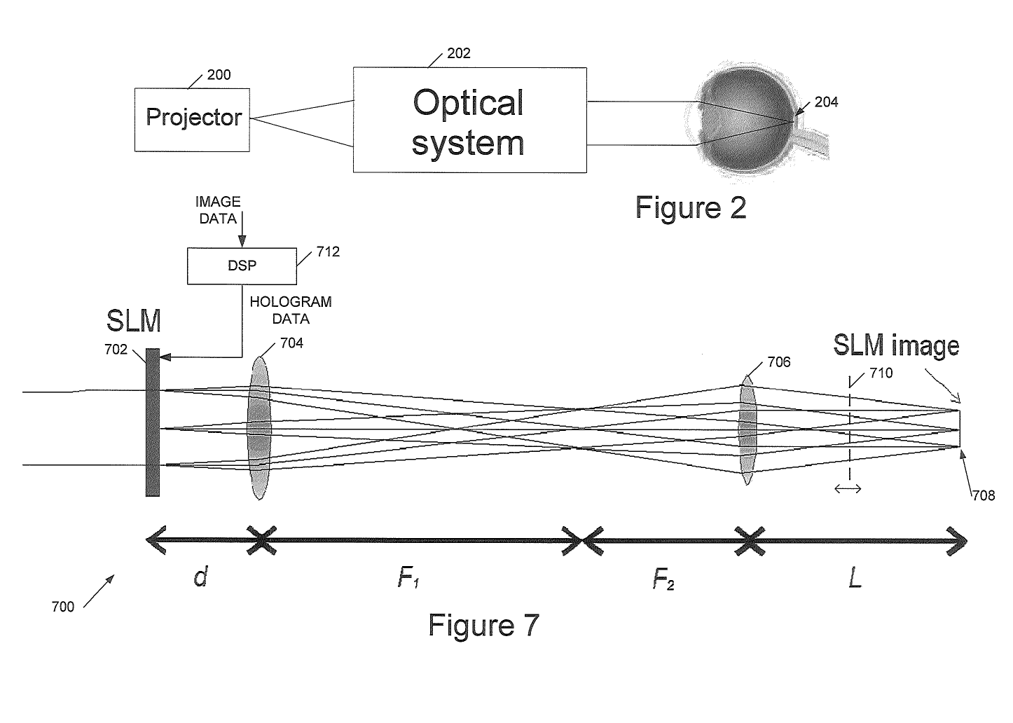

A virtual image display provides imagery in which the focal point of the projected image is some distance behind the projection surface, thereby giving the effect of depth. A general arrangement of such a system includes, but is not limited to, the components shown in FIG. 2. A projector 200 is used as the image source, and an optical system 202 is employed to control the focal point at the viewer's retina 204, thereby providing a virtual image display.

We will describe the use of a holographic projector used in a virtual image configuration for automotive and military head-up displays (HUDs), 2D near-to-eye displays, direct-view 3D displays; and also for military optical sights, and simultaneous multiple image planes images providing depth perception.

We have previously described, in PCT/GB2008/050224, the use of a holographic projector as a light source in a HUD system. This approach uses the holographic projector in an imaging configuration of the type shown, for example, in FIG. 5a, projecting onto a windshield or other screen. This approach benefits from the high efficiency of the holographic projection technology when displaying sparse HUD symbology.

However the inventors have recognised that advantages are possible if a HUD or HOS (holographic optical sight) is designed in different configuration, one which provides a virtual image direct to the eye.

This approach is shown in FIG. 7. Referring to FIG. 7, a head-up display 700 comprises a liquid crystal on silicon spatial light modulator (SLM) 702 which is used to display hologram patterns which are imaged by a lens pair 704, 706. A digital signal processor 712 inputs image data defining images in one or more two-dimensional planes (or in embodiments 3D image data which is then sliced into a plurality 2D image planes), and converts this image data into hologram data for display on SLM 702, in preferred embodiments using an OSPR-type procedure as described above. The DSP 712 may be implemented in dedicated hardware, or in software, or in a combination of the two.

An image of the SLM plane, which is the hologram plane, is formed at plane 708, comprising a reduced size version of the hologram (SLM). The observer's eye is positioned in this hologram plane. Upon observation of the imaged patterns, a human eye (more particularly the lens of the observer's eye) performs a Fourier transform of the hologram patterns displayed on the SLM thereby generating the virtual image directly.

Preferably, when applicable the resultant eye-box is expanded in effect to provide a larger exit pupil. A number of methods may be employed for this, for example a microlens array or diffractive beamsplitter (Fresnel divider), or a pair of planar, parallel reflecting surfaces defining a waveguide, located at any convenient point after the final lens 706, for example on dashed line 710. In some implementations of the system the arrangement of FIG. 7 may be, say, pointed out of a dashboard, or folded output optics may be employed according to the physical configuration desired for the application.

A particularly useful pupil expander is that we have previously described (in GB 0902468.8 filed 16 Feb. 2009, hereby incorporated by reference): a method and apparatus for displaying an image using a laser-based display system, comprising: generating an image using a laser light source to provide a beam of substantially collimated light carrying said image; and replicating said image by reflecting said substantially collimated light along a waveguide between substantially parallel planar optical surfaces defining outer optical surfaces of said waveguide, at least one of said optical surfaces being a mirrored optical surface, such that light escapes from said waveguide through one of said surfaces when reflected to provide a replicated version of said image on a said reflection.

Thus in this method/apparatus the rear optical surface is a mirrored surface and the light propagates along the waveguide by reflecting back and forth between the planar parallel optical surfaces, a proportion of the light being extracted at each reflection from the front face. In one implementation this proportion is determined by the transmission of a partially transmitting mirror (front surface); in another implementation it is provided by controlling a degree of change of polarisation of a beam between reflections at the (front) surface from which it escapes, in this latter case one polarisation being reflected, and an orthogonal polarisation being transmitted, to escape.

In the arrangement of FIG. 7, if the hologram merely encodes a 2D image the virtual image is at infinity. However the eye's natural focus is at ˜2 m and in some preferred embodiments therefore focal power at the SLM is encoded into the hologram, as described above, so that when rays from the virtual image are traced back they form a virtual image at a distance of approximately −2 m. Further, as will be appreciated from the above discussion of encoding lens power, the lens power, and hence the apparent distance of the virtual image, may be varied electronically by re-calculating the hologram (more specifically, the holographic subframes).

Extending this concept, different information can be displayed at different focal depth planes by encoding different lens powers when encoding the respective images for display. However, rather than employ, say, two different holograms for two different image planes, the holograms can be added to obtain one hologram which encodes both images at their different respective distances. This concept may be still further extended to display a 3D image as a series of 2D image slices, all encoded in the same hologram. We have also described above techniques for displaying full color holographic images in a system which projects onto a screen. These techniques may, by analogy, be applied to embodiments of a system of the type shown in FIG. 7 to obtain a full color holographic head-up image display.

Using the eye to perform Fourier transform in this way provides a number of advantages for a HUD/HOS system. The size and complexity of the optical system compared to that of a conventional non-holographic system is substantially reduced, due to the use of a diffractive image formation method, and because lens power can be incorporated into the hologram pattern. Also, since in embodiments the wavefront is directly controlled by the hologram pattern displayed on the SLM this makes it possible to correct for aberrations in the optical system by appropriate modification of the holograms, by storing and applying a wavefront correction (in FIG. 3d, multiplying guy by the wavefront conjugate—see PCT/GB2008/050224). Further, as mentioned above, since a portion of the total lens power is controlled by the hologram then the virtual image distance can be modified in software. This provides the capability for 3D effects in HUDs where, for example, a red warning symbol can be made to stand out against a green symbology background.

### 2D Near-to-Eve Displays

So-called near-to-eye displays include head mounted monocular and binocular displays such as those found on military helmets, as well as electronic viewfinders. The principle shown in FIG. 7 can be extended to such near-to-eye displays. Typically the virtual image distance is much smaller than the 2.5 m required for a HUD, and the encoded lens power is chosen accordingly, for example so that the virtual image is at an apparent distance of less than 50 cm. The optical system may also be miniaturised to facilitate location of the display close to the eye.

The use of a diffractive image formation method allows direct control over aberrations. Potentially therefore optical imperfections in the user's eye may be controlled and/or corrected, using a corresponding wavefront correction technique to that described above. Wavefront correction data may be obtained, for example, by employing a wavefront sensor or by measuring characteristics of an eye using techniques familiar to opticians and then employing an optical modelling system to determine the wavefront correction data. Zernike polynomials and Seidel functions provide a particularly economical way of representing aberrations.

### Direct-View 3D Displays

The above described principle can be extended to allow the display of true 3D imagery with full parallax. As it will be appreciated, application of such techniques (and those above) are not limited to HUD systems but also include, for example, consumer electronic devices.

One way to achieve a 3D display is by numerically computing the Fresnel-Kirchoff integral. If one regards an object as a collection of point-source emitters represented by the three-dimensional target field T(x, y, z), for an off-axis reference beam the Fresnel-Kirchhoff diffraction formula for the plane z=0 gives the complex EM field, that is the hologram H(u, v) which if illuminated results in the object T(x, y, z), as:

$$H ( u , v ) = \frac{1}{jλ} \int \int \int \frac{T ( x , y , z )}{r} \cdot {e}^{( \frac{2 πj}{λ} \cdot r )} d x d y d z$$

where r=□((u−x)²+(v−y)²+z²) is the distance from a given object point (x, y, z) to a point (u,v,0) in the hologram plane.

If we regard a 3D scene S as a number Sₙᵤₘ of point sources of amplitude Aₖ at (Xₖ, Yₖ, Zₖ) and wish to sample H(u, v) over a region {uₘᵢₙ≦u≦uₘₐₓ, vₘᵢₙ≦v≦vₘₐₓ} to form an M×M-pixel hologram Hᵤᵥ, we can thus write:

$${H}_{uv} = \frac{1}{jλ} {\sum }_{k = 1}^{{S}_{num}} \frac{{A}_{k}}{{r}_{k}} \cdot {e}^{( \frac{2 πj}{λ} \cdot {r}_{k} + {φ}_{k} )}$$

where the φₖ are uniformly random phases, to satisfy a flat spectrum constraint (equivalent to adding random phases to the target image pixels in the two dimensional case) and

$${r}_{k} = \sqrt{{( {u}_{min} + u \cdot \frac{{u}_{max} - {u}_{min}}{M} - {X}_{k} )}^{2} + {( {v}_{min} + v \cdot \frac{{v}_{max} - {v}_{min}}{M} - {Y}_{k} )}^{2} + {Z}_{k}^{2}}$$

An OSPR-type procedure which generates a set of N holograms Hᵤᵥ⁽¹⁾ . . . Hᵤᵥ^{(N)} to form a three-dimensional reconstruction of a scene S is then as follows:
1. Generate N fully-complex holograms by propagating Fresnel wavelets from Sₙᵤₘ point emitters of amplitudes Aₖ at at locations (Xₖ, Yₖ, Zₖ):

$${H}_{uv}^{( i )} = \frac{1}{jλ} {\sum }_{k = 1}^{{S}_{num}} \frac{{A}_{k}}{{r}_{k}} \cdot {e}^{( \frac{2 πj}{λ} \cdot {r}_{k} + {φ}_{k}^{( i )} )} 1 \leq i \leq N$$

2. Quantise these N hologram to binary phase, and output them time-sequentially to a display:

$${\hat{H}}_{uv}^{( i )} := \{ \begin{matrix}- 1 & Re ( {H}_{uv}^{( i )} ) \leq 0 \\ 1 & Re ( {H}_{uv}^{( i )} ) > 0\end{matrix} 1 \leq i \leq N$$

However such an approach is very slow for 3D images with a large number of points. Moreover, because the transform for Hᵤᵥ given above is not easily invertible more sophisticated approaches such as an ADOSPR-type approach are difficult to implement.

We therefore adopt an approach extending the principles given above, dividing the 3D image into 2D slices and setting a corresponding virtual image distance for each slice of the sequence. With such an approach an OSPR-type procedure can be used to dramatically increase the computation speed.

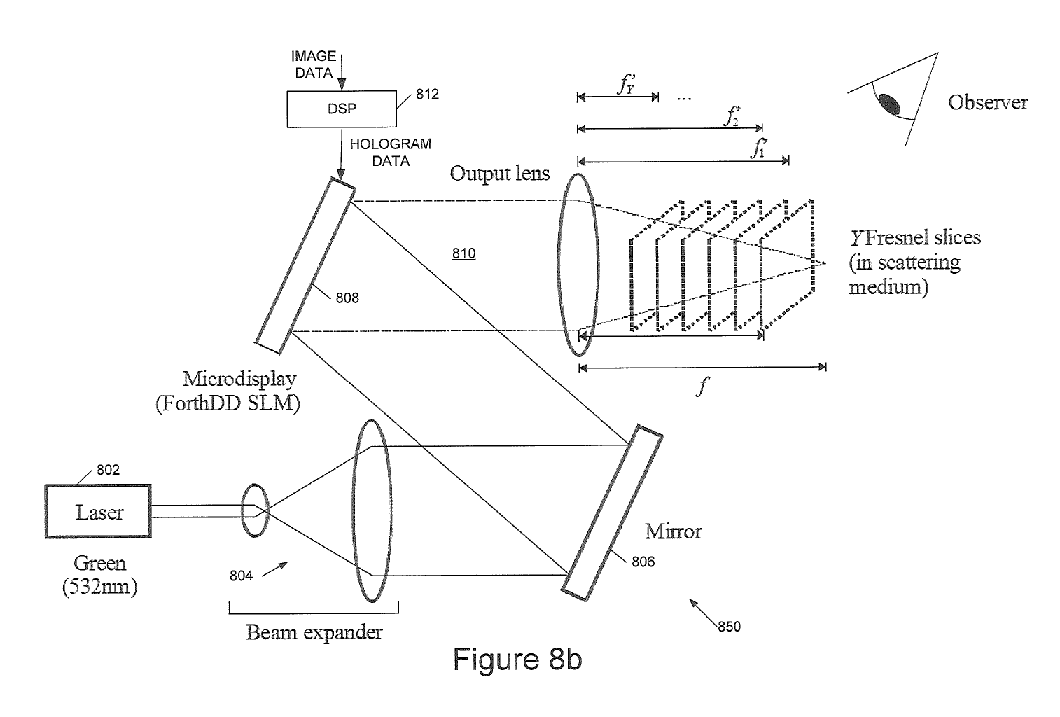

FIG. 8 shows an embodiment of a direct-view 3D holographic display 800. However the techniques we describe are not limited to such direct-view displays. In FIG. 8a low-power laser 802, for example a laser in which the laser power is reduced to <1 μW, provides coherent light to a beam expander 804 so that the beam is expanded at the pupil entrance. These features help to make the system eye-safe for direct viewing. In the illustrated example a mirror 806 directs the light onto a reflective SLM 808 (although a transmissive SLM could alternatively be employed), which provides a beam 808 to an observer's eye for direct viewing, using the lens of the eye to perform a holographic transform so that a virtual image is seen. A digital signal processor 812, similar to DSP 712 described above, inputs 3D image data, extracts a plurality of 2D image slices from this 3D data, and for each slice performs a holographic transform encoding the slice together with lens power to displace the slice to the z-position (depth) of the slice within the 3D image data so that it is displayed at an appropriate depth within the 3D displayed image. The DSP then sums the holograms for all the slices for display in combination on the SLM 808. Preferably an OSPR-type procedure is employed to calculate a plurality of temporal holographic subframes for each 3D image (ie for each set of 2D slices), for a fast, low-noise image display. Again DSP 812 may be implemented in dedicated hardware, or in software, or in a combination of the two.

Although FIG. 8 shows a system with single, green laser 802, the system may be extended, by analogy with the color holographic image display techniques previously described, to provide a full color image display.

Using OSPR it is possible to divide a 3D object into slices, forming each of the slices using an OSPR-calculated Fresnel hologram. If these Fresnel holograms are displayed time-sequentially then the eye integrates the resultant slices and a three-dimensional image is perceived. Furthermore, rather than time-multiplex the 3D image slices (which places a high frame-rate requirement upon the SLM as the slice count increases) it is possible to encode all slices into one binary hologram. We now describe in more detail how this may be achieved.

We have described above how a Fresnel transform can be used to add focal power to a hologram so that structure is formed not in the far field, but at a specific, nearer distance. The phase profile of a lens L(u,v) of focal length fᵥ is given by the expression:

$$L ( u , v ) = {e}^{\frac{2 πj}{λ} \cdot ( \frac{{u}^{2} + {v}^{2}}{2 {f}_{v}} )}$$

The generation of a Fresnel hologram that forms a near-field structure at a distance f′ from a lens of focal length f (ie. f′ from a lens of focal length f placed in front of the hologram plane) can be considered physically equivalent to compensation for a “phantom” defocus aberration of magnitude 1/(2fᵥ) waves, where fᵥ is given by

$${f}_{v} = \frac{f \cdot {f}^{′}}{f - {f}^{′}}$$

For a 3D direct-view architecture such as that shown in FIG. 8 there is no lens in front of the hologram, so effectively f=∞ and it therefore follows that fᵥ=f′. If we set fᵥ<0 we can use this approach to form a virtual image on a plane at a distance—fᵥ behind the hologram plane, which can be seen using the direct-view arrangement of FIG. 8. One can thus represent a three-dimensional image by breaking it up into a number Y of “slices” at distances f₁′ . . . f_{Y}′ so that each slice i represents a cross-section of points (x, y, fᵢ′) in the three-dimensional image.

One could generate a set of OSPR-type holographic subframes for each of the Fresnel slices and then display these time-sequentially. However to facilitate a large number of Fresnel slices without a substantial increase in SLM frame rate it is preferable to combine the wavefront data from the Y slices into a single hologram (displayed as a set of temporal holographic subframes), rather than to display Y separate holograms. There is, however, a trade-off between (computational cost and) maximum SLM frame rate and the drop in SNR for each slice resulting from multiplexing a progressively increasing number of slices. Thus, for example, embodiments may extract two or more sets of 2D slices from a 3D image and process each of these sets of 2D image slices according to the method we describe. Depending on the desired trade-off, employing more OSPR-type subframes will also reduce the perceived noise.

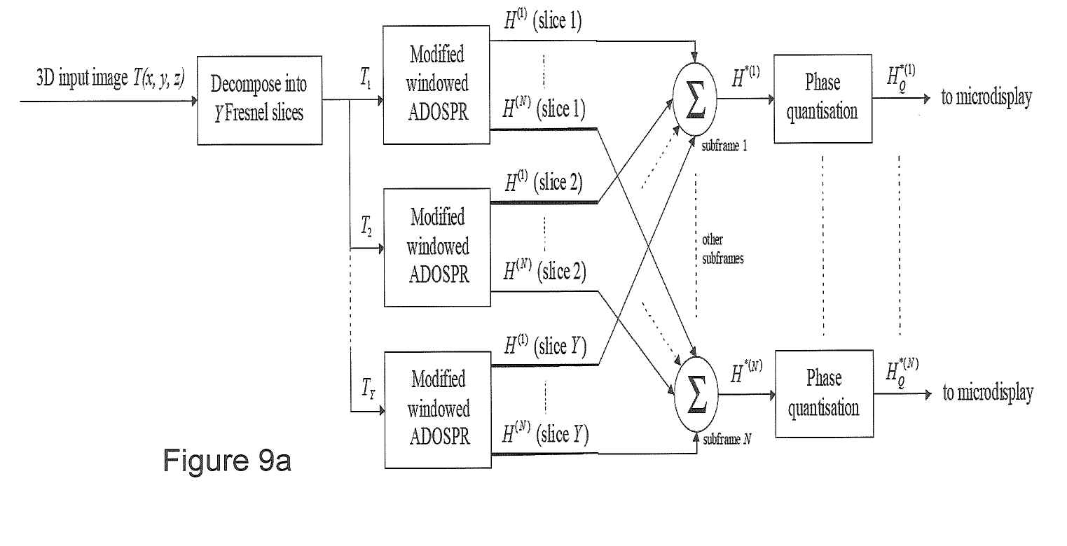

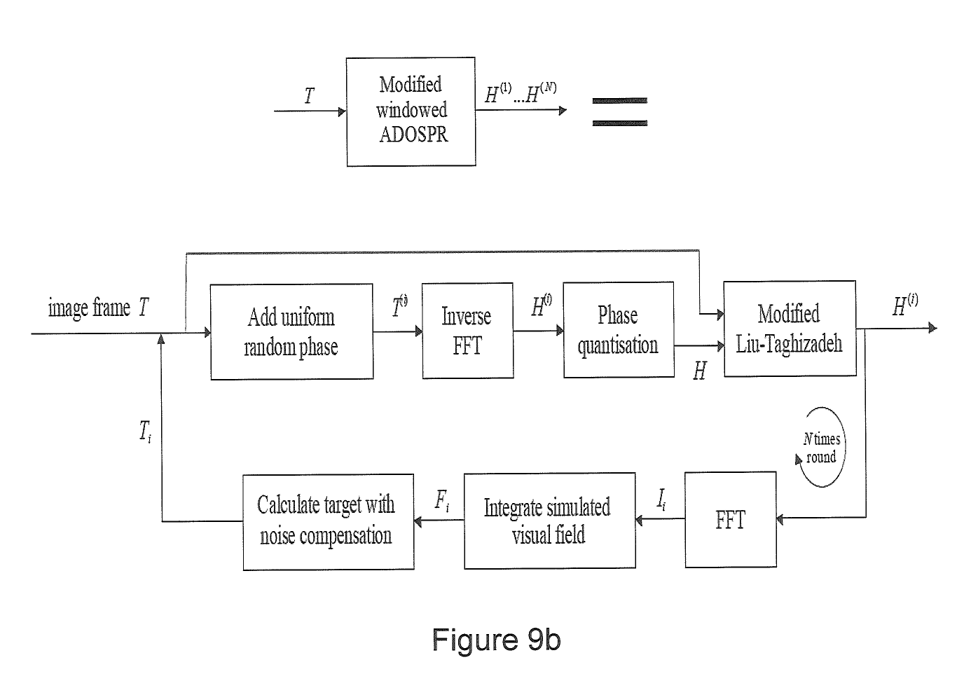

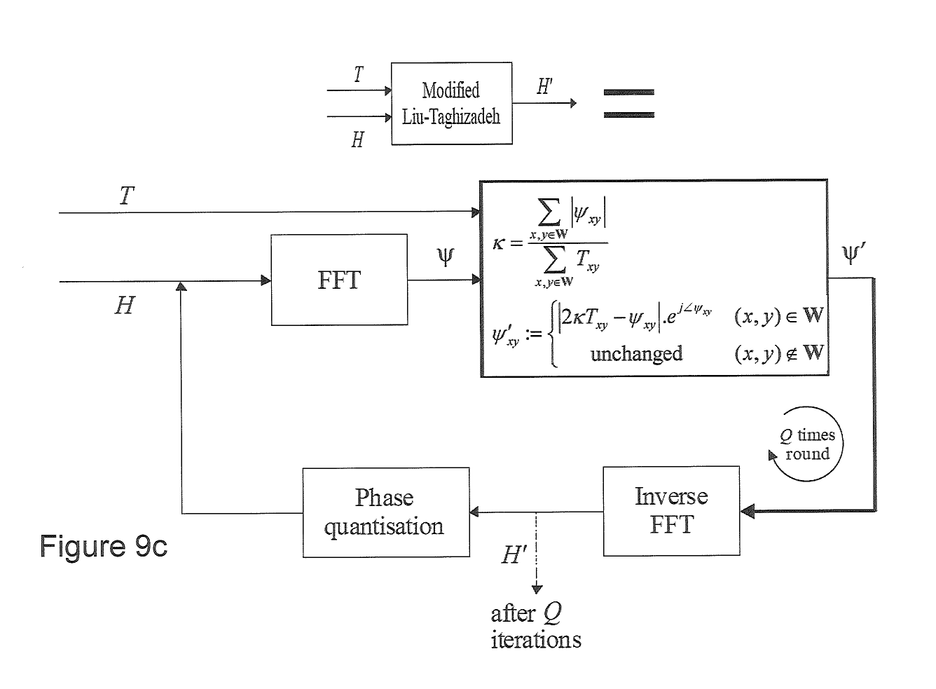

Because diffraction is a linear process, if binary holograms H₁ and H₂ represent Fresnel slice holograms such that H₁ forms an image X₁ at distance d₁, and H₂ forms an image X₂ at distance d₂, then the sum hologram H₁+H₂ will form the image X₁ at d₁, and also X₂ at d₂. The hologram H₁+H₂ will now contain pixel values in the set {−2, 0, 2}, but it is not necessary to employ a binary SLM to display the hologram. Alternatively the sum may be requantized to a binary set {−1, 1}, although the presence of zero-valued pixels will add quantization noise. One preferred approach is therefore to omit quantization operations prior to combining the (complex) hologram data, and then quantizing. This is illustrated in an example in FIGS. 9a to 9c, in this example for an ADOSPR-type procedure.

In the procedure we have previously described above, for each input image (for example video) frame, the final stage of the generation of each of the N holograms for each subframe is a quantization step which produces a quantized, for example binary, hologram from a fully-complex hologram. Here we modify the procedure to stop it a stage early, so that while the quantization operations inside, say, a Liu-Taghizadeh block take place for the first Q−1 iterations, for the final iteration Q the quantization stage is omitted, and it is the fully-complex, unquantized hologram that is produced and stored. This procedure is carried out independently for each of the Y Fresnel slices of the target 3D image, resulting in a set of Y×N fully-complex holograms, which have each been optimised for (say, binary) quantization, in this example by the corresponding Liu-Taghizadeh blocks. For each of the N subframes, we can thus sum the corresponding Y fully-complex Fresnel-slice holograms, and then apply a quantization operation to the sum hologram. The result is N quantized, for example binary, holograms, each of which forms as its reconstruction the entire 3D image comprising all the Fresnel slices. Thus, broadly, we perform slice hologram merging prior to quantization.

In embodiments of this technique the fully complex Fresnel slices for a given subframe are summed together and the sum is then quantized to form just a single (eg binary) hologram subframe. Thus an increase in slice count requires an increase in computation but not an increase in SLM frame rate (the SLM frame rate is the potentially more significant practical limitation).

Additionally, since in embodiments the computation for each of the Y slices is independent of the other slices, such an approach lends itself readily to parallelization. In some preferred implementations, therefore, the DSP 812 comprises a set of parallel processing modules each of which is configured to perform the hologram computation for a 2D slice of the 3D image, prior to combining the holograms into a common hologram. This facilitates real-time implementation.

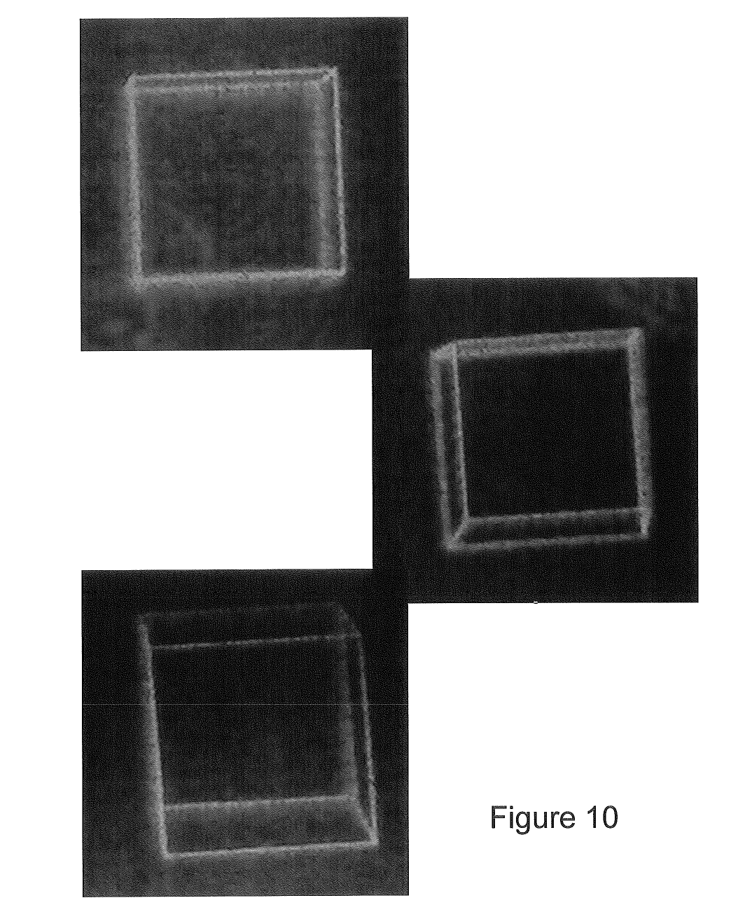

To demonstrate the efficacy of this approach a hologram set was calculated to form a wireframe cuboid of dimensions 0.012 m×0.012 m×0.018 m. The cuboid was sampled at intervals of 0.58 mm in the z-direction, giving Y=31 Fresnel slices, each of which was rendered at a resolution of 1024×1024 with N=24 holograms per subframe. Experimental results captured using a camera from three different positions close to the optical axis are shown in FIG. 10.

The technique can also be extended to produce direct-view three-dimensional color holograms. The experimental system used was based on the color projection system described above and illustrated in FIG. 5, with the demagnification optics 1014 removed and the laser powers reduced to <1 μW to make the system eye-safe for direct viewing. The test image used was composed of three Fresnel slices and comprising a red square at fᵥ=−1.5 cm , a green circle at fᵥ=−3 cm, and a blue triangle at fᵥ=−12 cm. The hologram plane scaling method described above was used to correct for wavelength scaling.

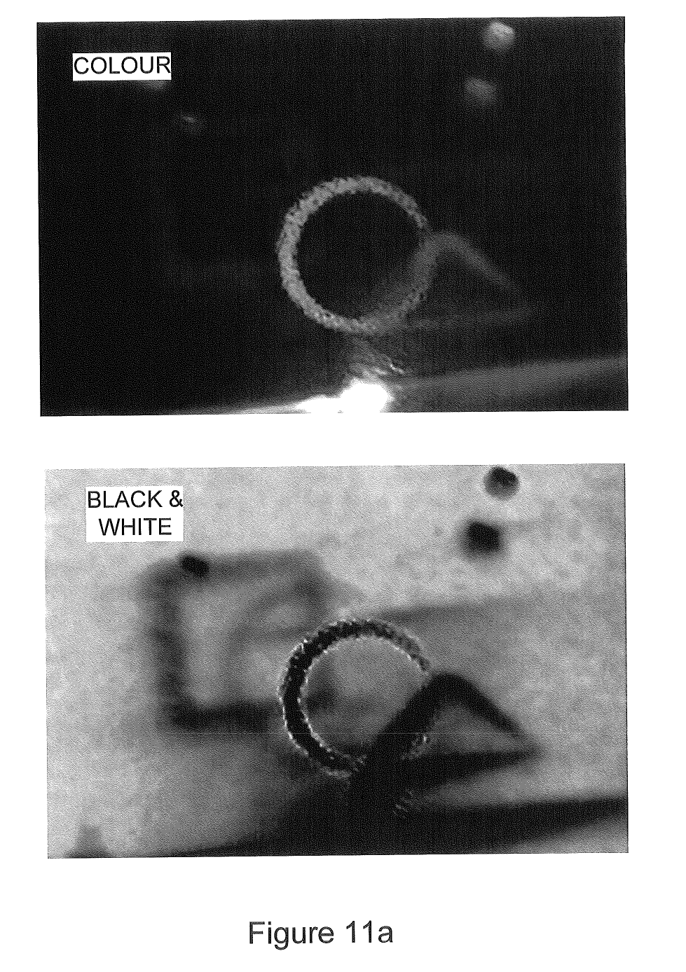

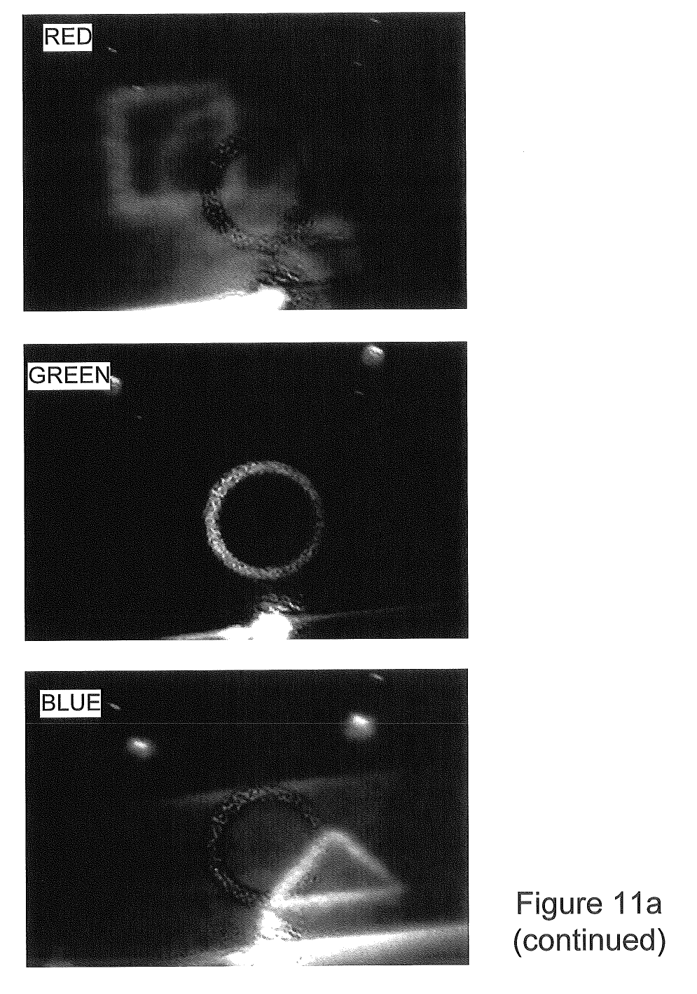

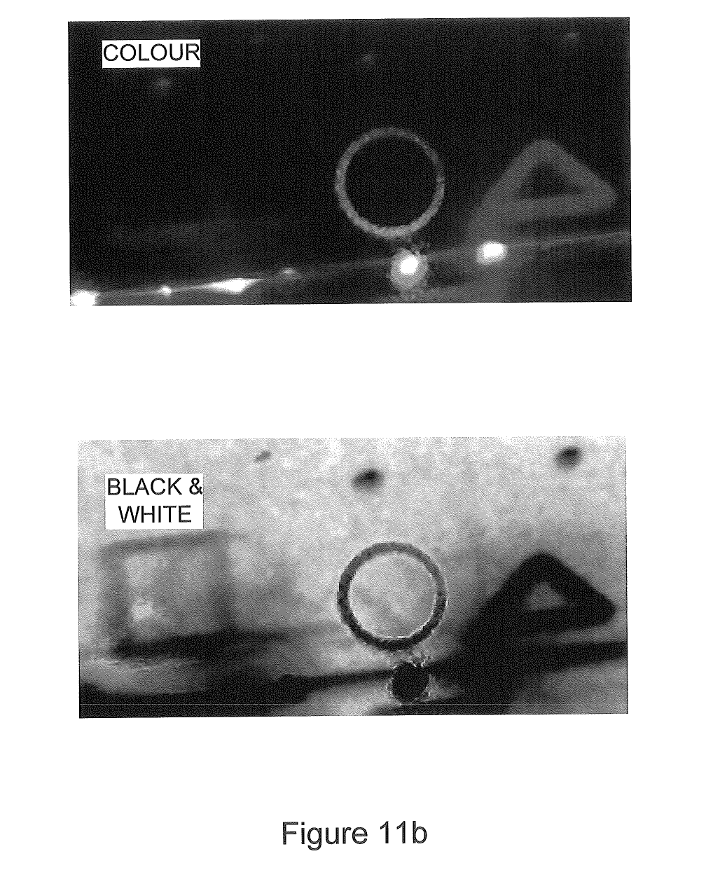

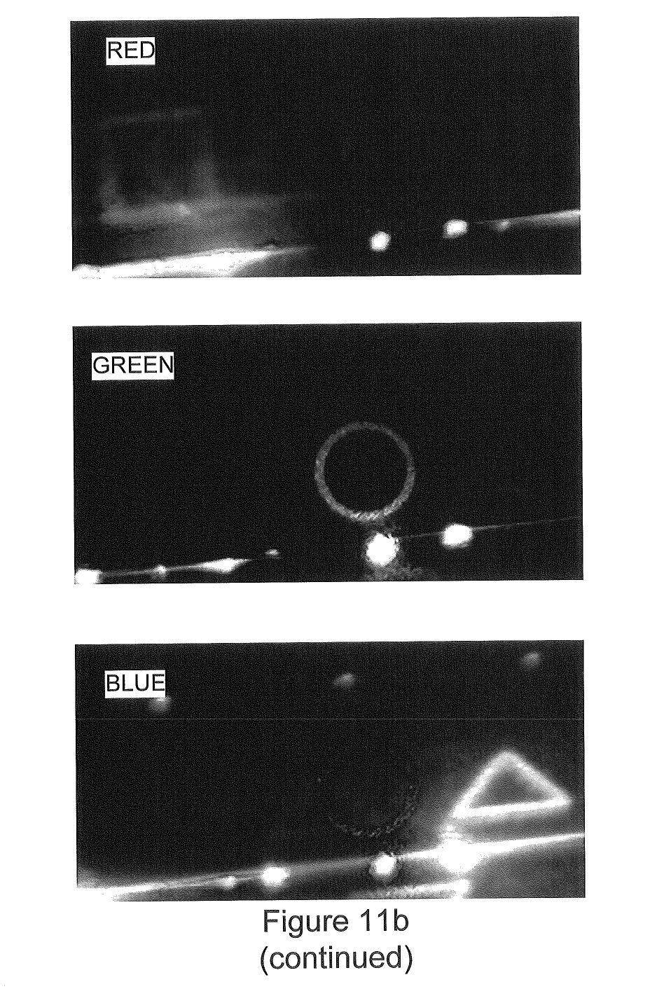

The results are shown in FIG. 11 (in which the red, green and blue color channels are also separated out labelled). The reconstruction was captured from two different positions close to the optical axis (FIGS. 11a and 11b respectively) and demonstrates significant parallax.

We have described above a direct-view three-dimensional display in which virtual image is formed behind the SLM and fᵥ is negative. If, however, fᵥ is positive we can calculate hologram sets using the Fresnel slice technique we have described to form a projected three-dimensional structure in front of the microdisplay (SLM). This is illustrated in FIG. 8b, which shows an example of a 3D holographic projection display 850 (in which like elements to those of FIG. 8a are indicated by like reference numerals).

Air does not scatter light sufficiently to directly form a three-dimensional “floating image” in free space but 3D images may be displayed using the apparatus of FIG. 8b if scattering particles or centers are introduced, for example with smoke or dry ice.

The techniques we describe above are applicable to a video display as well as to a still image display, especially when using an OSPR-type procedure. In addition to head-up displays, the techniques described herein have other applications which include, but are not limited to, the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod®” concept); advertising and signage systems; computer (including desktop); remote control unit; an architectural fixture incorporating a holographic image display system; and more generally any device where it is desirable to share pictures and/or for more than one person at once to view an image.

### Holographic Laser Projection for Optical Sights

We now describe using the holographic projection technique “retinal addressing” mode in optical sight displays.

### Retinal Addressing

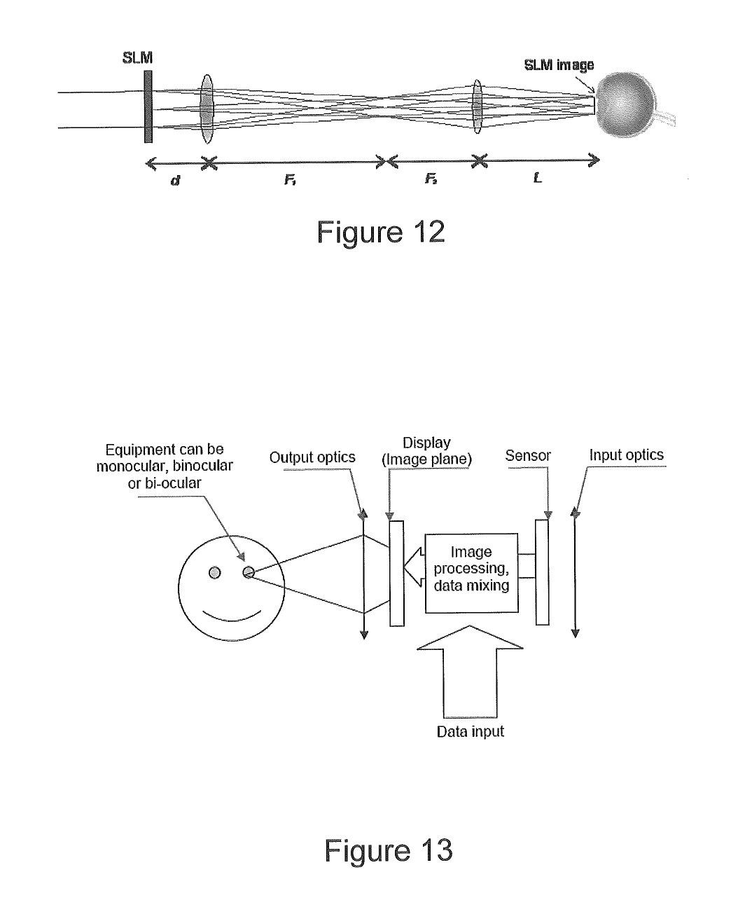

Using the above projection technique in a retinal addressing fashion means that the optical path is equivalent to the one of FIG. 12. In other words, we are creating a hologram with the SLM and the observer's eye is itself doing to reverse Fourier transform to form an image on the retina.

This method has the following advantages:
absence of diffuser on the optical path means no speckle is observable,
virtually any optical function (lens, aberration correction) can be applied to the virtual image showed. Particularly, its collimation distance can be changed in software.
   It also shows the following drawback:
the exit pupil of the system is extremely small (comparable to the SLM size).

### Optical Sight Displays

This term refers to targeting goggles or monoculars and by extension in this document, it also refers to optical observations means fitted accurately in front of 1 or 2 eyes to observe remote objects accurately. This includes:
periscopes (tanks, submarine and soldier use),
gun sights (either natural spectrum or enhanced vision like IR/I2),
night vision systems (NVG, range finders, IR goggles),
head mounted displays,
viewfinders (e.g. handheld devices and cameras).
   The reason why these applications are so well suited to retinal addressing is that, in all of them, there is an accurate knowledge of the eyes position which allows to address the viewer's retina directly. Such a system would for example be much more complex to use for a head up display where the viewer is expected to move his head within a certain space around the optics output.

### Benefit of Holographic Protection

Most of the optical sights are providing information on the observed scene. This information can be:
digits or text (displaying range, heading, position, elevation, etc . . . ),
cues (targeting cues scales, acquisition boxes, marked positions, etc . . . ),
enhanced vision (IR imaging, intensified image, sensor fusion, etc . . . ).
   This implies the use of a display device to superimpose this information to the observed scene. Note that sometimes, the observed scene is itself observed through a sensor. This is the case for example for night vision goggles that observed the scene though a light intensifier. Then this image is itself mixed with a display content to provide more information.

In the rest of the document, optical path of the scene observed (either directly or though a sensor) will be called “Primary channel” and the optical path of the information observed will be called the “Secondary channel”.

In one example, the Primary channel is the weapon sight (natural visible spectrum image) and the Secondary channel is the thermal imaging.

In another example the Primary channel is the direct view through the plate of the holographic combiner and Secondary channel is composed of a laser illuminated element that produces the image of the targeting cue.

In any case where a display or a laser illuminated pattern is used (normally, the display used is an OLED display from eMagin Corp.), we can replace it with retinal addressing. Moreover, the ability to superimpose aberration correction or optical functions brings more benefits. And finally, the laser illumination and color sequential nature of the above projection systems give high flux and color capabilities.

A list of the potential benefits includes the following:
reduction of optics (no duplication per channel) and gain in costs,
daylight operations for see through sights (high flux required),
software configurable multiple range cues (variable focal plane for information displayed),
multiple munitions (for gun sights, the target pattern can be adapted real time to the type of munitions used),
user adaptable (for users wearing glasses, compensation can be included in the sight by software),
sensor fusion (color capabilities required),
see-through sensor rendering (superimposing a sensor to the outside landscape high flux is preferable),
implementation of dynamic targeting aid or security clues in elementary gun sights (rifle),
software auto-focus of targeting clues.
   Embodiments of the invention can be divided into 2 categories that have a slightly different implementation:

1. Single channel sights,

2. Dual (or multiple) channel sights.

### Single Channel Sights

Note in this section that we are not speaking about passive optical sights that consist simply of optical magnification devices without any information superimposed on it. In other words, standard goggles are not considered.

A single channel sight might have the architecture of FIG. 13.

The most common instance of this architecture is night vision goggles. With the remarkable particularity that the sensor and the display are part of the same component called light intensifier. In this case, there is no easy way to superimpose information on the image and consequently there is no data input in most cases.

In single sensor night vision goggles, it is possible to see that, because of the nature of this equipment, three are 3 optics tuning rings:
one for the input optics,
one for each eye (output optics).
   This practically makes the equipment a bit long to tune and practically very hard to change focus in operations.

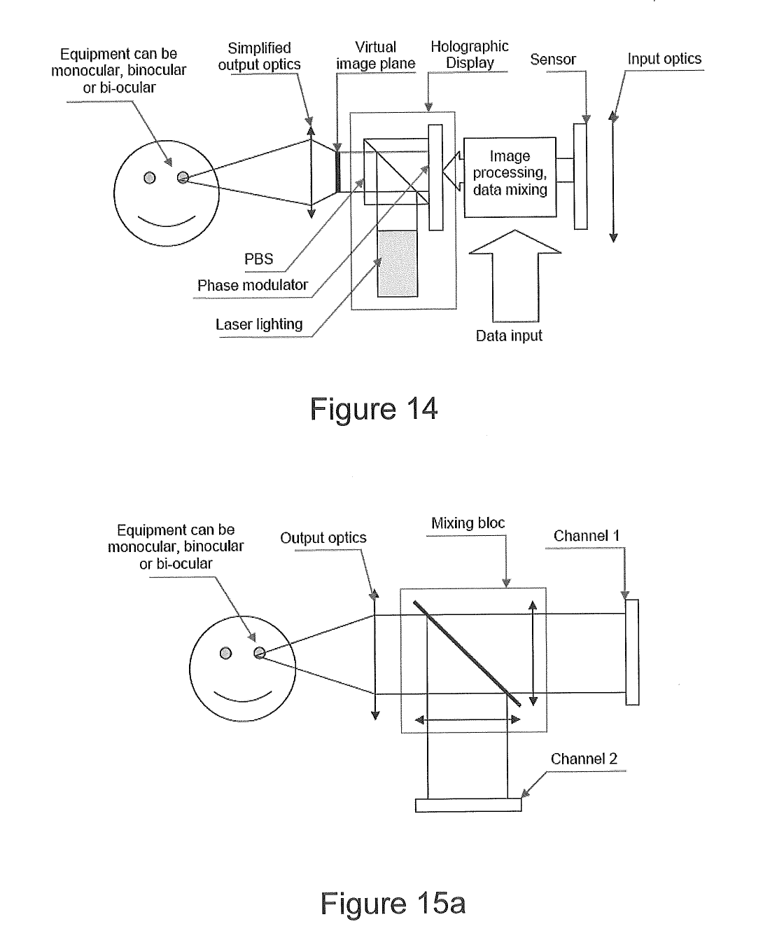

Now for comparison, if we consider the block diagram of such single channel system implemented with holographic projection based retinal addressing, it should look like FIG. 14.

Despite looking more complex, this architecture releases constraints on the optical architecture, specifically on the output optics. Because the image produced by the holographic display is a phase hologram, it can contain a correction for the aberrations of the output optics and make it much simpler and lower cost. Another benefit is to be able to change the focus of the image without actually using any mechanical component. This could for example be used to tune the image focus accordingly to the focus of the input optics. Finally, the phase hologram generation benefits a very good light efficiency and is capable of generating color images.

Note that the sensors can be multiple and the image processing can include:
graphic generation (adding digits, text, scales or cues),
image enhancement (contrast, noise, gamma, to spots, etc . . . ),
sensors mixing (extraction and mixing of different sensors),
sensors fusion (extracting analysis and intelligent mixing of different sensors).

This makes this architecture versatile.

### Dual or Multiple Channel Sights

The dual or multiple channel sights are composed of at least two optical paths mixed prior to the output optics and aim at superimposing different views or the same scene.

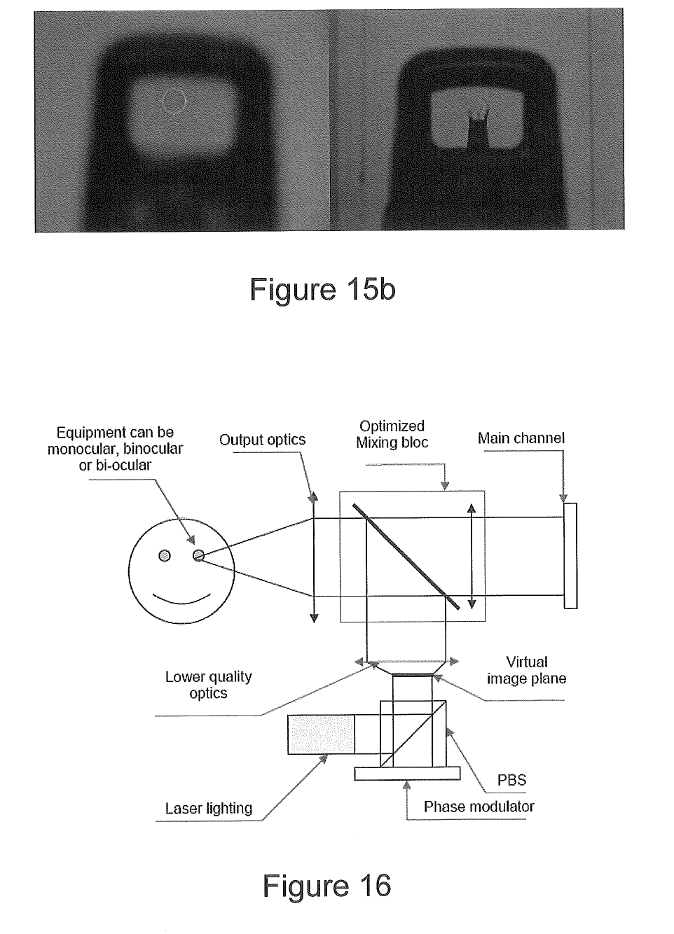

The general block diagram of such sight could be as shown in FIG. 15a.

In FIG. 15a each channel can be:
a direct view or magnified direct view,
a display linked with a sensor (e.g. light intensifier),
a display linked to a graphic generation to add information or synthetic graphics.
   The complexity of these architectures lies in the choice of an optical mixing of the channels rather than a digital mixing and single channel. Therefore the mixing block is normally a costly and complex element that must adapt and mix the different channels so that they are accurately and consistently presented to the viewer though the output optics. Specifically for such systems, the focus is virtually impossible to unify and (apart from direct view) sensors or information presented stay in a unique plane.

If we take the example of a given sight (FIG. 15b), one channel is the direct view (×1 magnification) and the second channel is a holographic reticule cue collimated in the infinite.

In the case of this specific gun sight, the limitation is visible but not harmful to the function as accurate targeting is normally used only for remote objects. It is more of a problem in multi sensor sights.

In an example, three channels may comprise, for example:
a light intensifier objective,
an imager (e.g. OLED microdisplay),
direct view of the outside landscape.
   In this system, the light intensifiers’ focus (one per eye) is tuneable but not the imager's input. In case of close night manoeuvres, it prevents the user of the sight from keeping their information consistent with the light intensification or the outside landscape observation (when conditions allow it). More generally speaking, managing focus is an increasingly complex mechanism when the number of channels increases.

A dual channel system using retinal addressing holographic projection could be configured as shown in FIG. 16.

Such architecture has several advantages amongst which:
capacity to offer high flux images (by opposition to OLED displays) and hence, daylight compatible equipment (or all lighting conditions compatible),
use of laser light makes the mixing block more efficient.
Ability to correct for optical aberration all along the optical path and until the user's eye allows to design the optics for optimization of the “main channel” knowing that the imperfections of the holographic channel can be compensated for in software.
ability to add a lens function in software allows:
   to display information in different planes visible at the same time (mainly for see-through systems),
   to tune electronically the focus of the holographic channel with the one of the main channel (likely to remain mechanical).

### Potential Variations

Some variants of the architectures presented above are worth mentioning as they use slightly different properties of holographic projection.

### Collimated Image and Pupil Expander

In the specific case of an optical system for observation of remote objects with low magnification (typically×1), the most important parameter may be the degree of freedom in the observer's position. In such case, the exit pupil needs to be expanded.

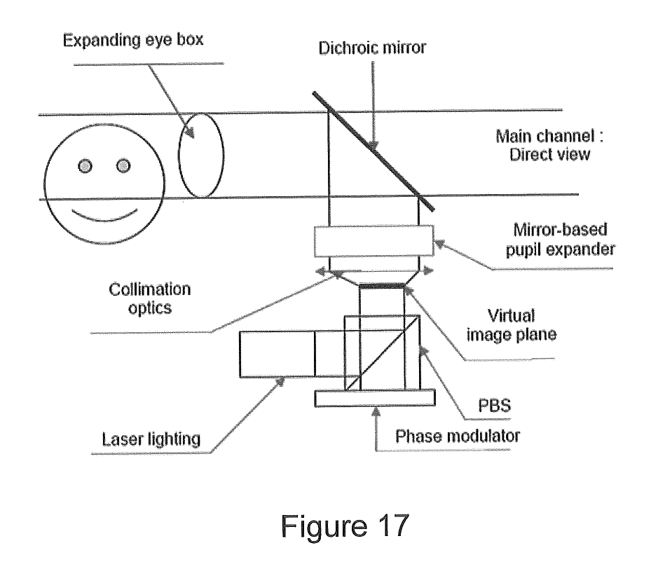

A good example is a gun sight application, as shown in FIG. 17.

The introduction of the pupil expander can be generalized to any applications showing infinitely collimated images and requiring a large eyebox.

### Output Optics Addressing a Sensor

Another possible variation of the block diagrams is the case in which the output optics forms and image on a sensor. This case may look slightly unusual but it typically corresponds to systems where the observer sees the world though night vision goggles. In such mode, we can for example consider that we want to use standard NVG and superimpose some information on it. Therefore we have a dual channel system where:
the primary channel is the direct view of the outside world (maybe though some magnification optics),
the secondary channel is an image projected by a holographic projector,
the output optics addresses a light intensifier.
   In this mode, it is important that the secondary channel is able to form an image within the spectral response of the light intensifiers (normally using a spectrum shifted towards the red). Therefore the possibility to select the spectrum of the image projected is useful in this case.

### Medical Applications of the Principle

Another way to use the above mentioned retinal addressing sight is to provide sight aid to people with some degenerative sight problems. Presenting them with pictures including certain aberration correction can help:
showing them content that they can not see sharply (TV, computer screen, outside world viewed through a camera),
characterizing the aberration or tracking the evolution of their aberration (by presenting patterns and asking the user to evaluate and tune the parameters of the correction).

This application is comparable to a single channel sight system in which the part of the optics corrected for is mainly the observer's eye and can be implemented in a headset or in fixed based test material (at an ophthalmologist for example).

The techniques we describe above are applicable to a video display as well as to a still image display, especially when using an OSPR-type procedure.

In conclusion, the invention provides novel systems, devices, methods and arrangements for display. While detailed descriptions of one or more embodiments of the invention have been given above, no doubt many other effective alternatives will occur to the skilled person. It will be understood that the invention is not limited to the described embodiments and encompasses modifications apparent to those skilled in the art lying within the spirit and scope of the claims appended hereto.

1. A holographic head-up display (HUD) for displaying a virtual image comprising one or more substantially two-dimensional images, the head-up display comprising:
a laser light source;
a spatial light modulator (SLM) to display a hologram of said one or more substantially two-dimensional images;
illumination optics in an optical path between said laser light source and said SLM to illuminate said SLM; and
imaging optics to image a plane of said SLM comprising said hologram into an SLM image plane in said eye box such that the lens of the eye of an observer of said head-up display performs a space-frequency transform of said hologram on said SLM to generate an image within said observer's eye corresponding to said one or more substantially two-dimensional images.

2. A holographic head-up display as claimed in claim 1 further comprising a processor having an input to receive image data for display and an output for driving said SLM, and wherein said processor is configured to process said image data and to output hologram data for display on said SLM in accordance with said image data for displaying said one or more substantially two-dimensional images to said observer.

3. A holographic head-up display as claimed in claim 2 wherein said hologram displayed on said SLM encodes focal power such that a said substantially two-dimensional image is at an image distance from said observer's eye of less than 10 meters.

4. A holographic head-up display as claimed in claim 2 wherein said hologram displayed on said SLM encodes focal power, and wherein said processor has an input to enable said focal power to be adjusted to adjust an image distance of a said substantially two-dimensional image from said observer's eye.

5. A holographic head-up display as claimed in claim 2 wherein said hologram displayed on said SLM encodes a plurality of said substantially two-dimensional images at different focal plane depths such that said substantially two-dimensional images appear at different distances from said observer's eye.

6. A holographic head-up display as claimed in claim 2 wherein said hologram displayed on said SLM encodes a plurality of lenses having different respective powers, each associated with a respective hologram encoding a said substantially two-dimensional image, such that said head-up display displays said substantially two-dimensional images at different distances from said observer's eye.

7. A holographic head-up display as claimed in claim 2 for displaying images in at least two different colors, and wherein two images at different distances from said observer's eye have different respective said colors.

8. A holographic head-up display as claimed in claim 1 further comprising fan-out optics to form a plurality of replica imaged planes of said SLM to enlarge said eye box.

9. A holographic head-up display as claimed in claim 8 wherein said fan-out optics comprise a microlens array or diffractive beam splitter.

10. A holographic head-up display as claimed in claim 1 wherein said processor is configured to generate a plurality of temporal holographic subframes, each encoding all of said one or more substantially two-dimensional images, for display in rapid succession on said SLM such that corresponding images within said observer's eye average to give the impression of said one or more substantially two-dimensional images with less noise than the noise of an image would be from one of said temporal holographic sub-frames.

11. (canceled)

12. A three-dimensional holographic virtual image display system, the system comprising:
a coherent light source;
a spatial light modulator (SLM), illuminated by said coherent light source, to display a hologram; and
a processor having an input to receive image data for display and an output for driving said SLM, and wherein said processor is configured to process said image data and to output hologram data for display on said SLM in accordance with said image data;
wherein said image data comprises three-dimensional image data defining a plurality of substantially two-dimensional images at different image planes, and wherein said processor is configured to generate hologram data defining a said hologram encoding said plurality of substantially two-dimensional images, each in combination with a different focal power such that, on replay of said hologram, different said substantially two-dimensional images are displayed at different respective distances from an observer's eye to give an observer the impression of a three-dimensional image.

13. A three-dimensional holographic virtual image display system as claimed in claim 12 wherein said three-dimensional image data defines a three-dimensional image, wherein said processor is configured to extract a plurality of sets of two-dimensional image data from said three-dimensional image data, said sets of two-dimensional image data defining a plurality of slices through said three-dimensional image; wherein said processor is configured to perform for each said set of two-dimensional image data a holographic transform encoding into a hologram for a said slice a combination of said two-dimensional image data and lens power to displace a replayed version of said two-dimensional image data to appear in a position of a said slice defined by a position of said two-dimensional image data in said three-dimensional image; and wherein said processor is configured to combine said holograms for said slices to generate said hologram data for display on said SLM.

14. A three-dimensional holographic virtual image display system as claimed in claim 13 wherein said holographic transform comprises a Fresnel transform.

15. A three-dimensional holographic virtual image display system as claimed in claim 12 wherein said coherent light source is configured to provide coherent light of at least two different time-multiplexed colors, wherein said processor is configured to generate at least two sets of said hologram data, one for each color of said coherent light, for time-multiplexed display on said SLM in synchrony with said time-multiplexed colors to provide a said three-dimensional image in at least two colors; and wherein said hologram data is scaled such that pixels of said substantially two-dimensional images formed by said hologram data for said different colors of coherent light have substantially the same lateral dimensions within each plane defined by a said displayed two-dimensional image.

16. A three-dimensional holographic virtual image display system as claimed in claim 12 further comprising imaging optics to image a plane of said SLM comprising said hologram into an SLM image plane such that the lens of the eye of an observer of said head-up display performs a space-frequency transform of said hologram on said SLM to generate an image within said observer's eye corresponding to said three-dimensional image.

17. A three-dimensional holographic virtual image display system as claimed in claim 16 further comprising fan-out optics to form a plurality of replica imaged planes of said SLM.

18. A three-dimensional holographic virtual image display system as claimed in claim 12 wherein said processor is configured to generate a plurality of temporal holographic subframes, each encoding all of said substantially two-dimensional images, for display in rapid succession on said SLM such that corresponding images within said observer's eye average to give the impression of said three-dimensional image with less noise than the noise of an image would be from one of said temporal holographic sub-frames.

19. A three-dimensional holographic virtual image display system as claimed in claim 12 wherein said coherent light source comprises a laser light source, the system further comprising illumination optics in an optical path between said laser light source and said SLM to illuminate said SLM and expand a beam of said laser light source to facilitate direct viewing of said three-dimensional image by said observer.

20-24. (canceled)

25. A holographic optical sight (HOS) for displaying a virtual image comprising one or more substantially two-dimensional images, the optical sight comprising:
a laser light source;
a spatial light modulator (SLM) to display a hologram of said one or more substantially two-dimensional images;
illumination optics in an optical path between said laser light source and said SLM to illuminate said SLM; and
imaging optics to image a plane of said SLM comprising said hologram into an SLM image plane such that the lens of the eye of an observer of said optical sight performs a space-frequency transform of said hologram on said SLM to generate an image within said observer's eye corresponding to said one or more substantially two-dimensional images.

26. A holographic optical sight as claimed in claim 25 further comprising a processor having an input to receive image data for display and an output for driving said SLM, and wherein said processor is configured to process said image data and to output hologram data for display on said SLM in accordance with said image data for displaying said one or more substantially two-dimensional images to said observer.

27. A holographic optical sight as claimed in claim 25 further comprising a polarizing beam splitter optically coupled between said illumination optics, said SLM and said imaging optics, and wherein said holographic optical sight has a virtual image plane for said image generated by said hologram between said polarizing beam splitter and said imaging optics.

28. A holographic optical sight as claimed in claim 26 wherein said hologram displayed on said SLM encodes focal power, and wherein said processor has an input to enable said focal power to be adjusted to adjust an image distance of a said substantially two-dimensional image from said observer's eye.

29. A holographic optical sight as claimed in claim 26 wherein said hologram displayed on said SLM encodes a plurality of said substantially two-dimensional images at different focal plane depths such that said substantially two-dimensional images appear at different distances from said observer's eye.

30. A holographic optical sight as claimed in claim 26 wherein said hologram displayed on said SLM encodes a plurality of lenses having different respective powers, each associated with a respective hologram encoding a said substantially two-dimensional image, such that said optical sight displays said substantially two-dimensional images at different distances from said observer's eye.

31. A holographic optical sight as claimed in claim 27 for displaying images in at least two different colors, and wherein two images at different distances from said observer's eye have different respective said colors.

32. A holographic optical sight as claimed in claim 25 further comprising fan-out optics to form a plurality of replica imaged planes of said SLM to enlarge an eye box of for viewing said image.

33. A holographic optical sight as claimed in claim 32 wherein said fan-out optics comprise a microlens array, diffractive beam splitter, or a pair of planar, parallel reflecting surfaces defining a waveguide.

34. A holographic optical sight as claimed in claim 25 wherein said processor is configured to generate a plurality of temporal holographic subframes, each encoding all of said one or more substantially two-dimensional images, for display in rapid succession on said SLM such that corresponding images within said observer's eye average to give the impression of said one or more substantially two-dimensional images with less noise than the noise of an image would be from one of said temporal holographic sub-frames.

35-44. (canceled)

45. A holographic optical sight as claimed in claim 25, wherein the holographic optical sight is configurable to display a said hologram calculated to correct aberrations in one or both of mixing and output (imaging) optics of said sight.

46. A holographic optical sight as claimed in claim 25, wherein the holographic optical sight further includes a memory operable to store aberration correction data for a user's eye, and wherein said hologram is generated to correct for aberration of said user's eye defined by said aberration correction data.
